(19) United States
(12) Patent Application Publication
(10) Pub. No.: US 2008/0106997 A1
(43) Pub. Date: May 8, 2008

(54) Objective lens optical system

(75) Inventors: Tomonori Kanai, Ibaraki-shi (JP); Takesuke Maruyama, Ibaraki-shi (JP); Koichiro Wakabayashi, Ibaraki-shi (JP); Yoshikazu Mitsui, Ibaraki-shi (JP); Mitsuhiro Miyauchi, Ibaraki-shi (JP); Yasuyuki Sugi, Ibaraki-shi (JP)

Correspondence Address: OLIFF & BERRIDGE, PLC, P.O. BOX 320850, ALEXANDRIA, VA, 22320-4850, US

(73) Assignee: HITACHI MAXELL, LTD., Ibaraki-Shi (JP)

(21) Appl. No.: 11/979,710

(22) Filed: Nov. 7, 2007

(30) Foreign Application Priority Data
Nov. 8, 2006 (JP) 2006-302693
Dec. 28, 2006 (JP) 2006-355226

(51) Int. Cl. G11B 7/135

(52) U.S. Cl. 369/112.23

(57) ABSTRACT

An objective lens optical system focuses a light beam with a wavelength λ₁ on an information recording surface of a first optical recording medium including a transparent substrate with a thickness t1, a light beam with the wavelength λ₁ on an information recording surface of a second optical recording medium including a transparent substrate with a thickness t2, and a light beam with a wavelength λ₃ on an information recording surface of a third optical recording medium including a transparent substrate with a thickness t3, by using a refraction action. Sectioning the area of the objective lens optical system is applied to a compatible technique for the same wavelengths, and generating an aberration for canceling a chromatic aberration caused by a difference in wavelength λ of the light beam is applied to a compatible technique for different wavelengths.

### BACKGROUND OF THE INVENTION

1. Field of the Invention

The present invention relates to an objective lens optical system or an optical pickup optical system capable of recording or reproducing data on/from a plurality of types of optical recording medium each having a different thickness.

2. Description of Related Art

Conventionally, an objective lens optical system for focusing light on different optical recording medium has been developed. For example, there is disclosed a technique in Japanese Patent Application Laid-open No. 2001-195769 that focuses light on two different optical recording medium by utilizing a chromatic aberration caused by a wavelength difference and a wavefront aberration caused by thickness of a transparent substrate (hereinafter called a compatible technique). However, it is difficult to apply this compatible technique in the case of focusing light of the same wavelength on optical recording medium having different thicknesses.

Moreover, as a compatible technique in the case of the same wavelength, there is disclosed a technique in Japanese Patent Application Laid-open No. 2006-12391. According to this technique, a polarization-plane changing element which selectively changes the polarization direction of a light beam is required. Therefore, there are problems of increasing in the number of parts, and in the size and weight of the objective lens optical system.

Moreover, as another compatible technique in the case of the same wavelength, as described in Japanese Patent Application Laid-open No. 10-143905, there is a technique in which light is focused on different optical recording medium by sectioning the area of the objective lens optical system. However, since each area of the objective lens optical system for focusing light on each optical recording medium can focus the light only on respective optical recording medium, if focusing the light on three or more optical recording medium, problems such as a laser power increase due to lowering of the light use efficiency, and processing of stray light will occur.

A technique for solving the problem that each area of the objective lens optical system for focusing light on each optical recording medium can focus the light only on respective optical recording medium is disclosed in Japanese Patent Application Laid-open No. 2000-28917. According to this technique, an area for focusing light on both the two medium is provided. However, since a diffractive structure is used for a compatible technique of this area, the light use efficiency is lowered because of the diffraction efficiency, which still results in the problem of a laser power increase due to lowering of the light use efficiency and processing of stray light.

As described above, in the case of applying such objective lens optical system to the conventional technique, there has been occurred the problem, such as a laser power increase due to lowering of the light use efficiency, and processing of stray light.

It is an object of the present invention to improve the light use efficiency and reduce stray light of an objective lens optical system in which the wavelengths of light beams to be focused on at least two or more optical recording medium are the same, the wavelengths of light beams to be focused on at least two or more optical recording medium are different, and light is focused on at least three or more optical recording medium, thereby providing the objective lens optical system of high performance.

### SUMMARY OF THE INVENTION

A premise technique of the present invention will now be explained briefly at the beginning, and then a concrete structure of the present invention will be described.

Firstly, according to the present invention, sectioning the area of an objective lens optical system is applied to a compatible technique in the case of using light beam having the same wavelength (hereinafter called a compatible technique A), and providing a structure in which a phase is changed so that an aberration of a focusing point on the information recording surface with respect to the height of an arbitrary light may be within an allowable range is applied to a compatible technique in the case of using light beams having different wavelengths (hereinafter called a compatible technique B).

The compatible technique B can be realized by a structure in which a phase is changed so as to compensate a wavefront aberration generated when performing recording or reproducing on/from an optical recording medium of a substrate thickness t1 by using a light beam of a wavelength λ₁ and a wavefront aberration generated when performing recording or reproducing on/from an optical recording medium of a substrate thickness t3 by using a light beam of a wavelength λ₃. In the compatible technique B, aberrations to be taken into consideration are a wavefront aberration (aberration α) caused by a difference in substrate thickness, a chromatic aberration (aberration β) caused by a difference in refractive index between an objective lens and a substrate of an optical recording medium based on a light beam wavelength difference, and a chromatic aberration (aberration γ) generated by aspherizing the surface of an objective lens to be a high-order aspherical surface by utilizing a wavelength difference.

As the compatible technique B, there are a technique (B1) which enables compatibility by cancelling the aberration a by the aberrations β and γ, and a technique (B2) which enables compatibility by cancelling the aberration β by the aberration γ. The former compatible technique B1 can be realized, for example, by forming a high-order aspherical surface structure in which a phase is changed so that a chromatic aberration (aberration β) caused by a difference in wavelength and a wavefront aberration (aberration α) caused by a difference in transparent substrate thickness may cancel each other, which is disclosed in, e.g., Japanese Patent Application Laid-open No. 2003-270528. The latter compatible technique B2 can be realized, in the case of the same substrate thicknesses and different wavelengths like a HDDVD and a DVD, by cancelling a chromatic aberration (aberration β) due to a wavelength difference by a chromatic aberration (aberration γ) generated in the high-order aspherical surface structure.

Thus, with the structure in which both the compatible techniques A and B are applied, it becomes possible to achieve compatibility in the case of the same wavelengths, and to improve the light use efficiency and reduce stray light in the compatibility in the case of different wavelengths, thereby providing an objective lens optical system of high performance.

Secondly, in at least a part of the objective lens optical system, the area of the above-stated structure of changing a phase is sectioned by the area of a optical recording medium on which no light is focused by the area of the above-stated structure of changing a phase, and an optical path length difference between the areas at the inner side and the outer side of the sectioned area is made to be greater than or equal to 0.5λ with respect to each of the optical recording medium on which light is focused by the area of the structure of changing the phase. In other words, when it is supposed that a common area is arranged in all the area of the objective lens, an exclusive area is provided at the area where an absolute value or a change of a wavefront aberration with respect to one of the optical recording medium that use the common area becomes the largest. By having such a structure, it becomes possible to reduce the large aberration of the structure of changing a phase generated in the compatible technique B, thereby providing an objective lens optical system of high performance.

Thirdly, when the relation of a thickness t1 of a transparent substrate corresponding to a light beam λ₁, a thickness t2 of a transparent substrate corresponding to the light beam λ₁, and a thickness t3 of a transparent substrate corresponding to a light beam λ₃ is assumed to be |t3−t1|>|t3−t2|, it is configured in an NA area corresponding to t3 to focus light beam on optical recording medium corresponding to t2 and t3 (compatible technique B), not to focus light on an optical recording medium corresponding to t1 (compatible technique A) but. Owing to such a structure, in the neighborhood of the NA where it is difficult to focus light on an optical recording medium corresponding to t3, it becomes possible to achieve compatibility with an optical recording medium corresponding to t2 with respect to which a difference of a wavefront aberration due to a difference in thickness is smaller than that with respect to an optical recording medium corresponding to t1, thereby providing an objective lens optical system of high performance.

Fourthly, an area for focusing light beam on optical recording medium corresponding to t1 and t3 is provided at the inner side of the NA area corresponding to t3. Since the use area of t1 increases by having such a structure, the light use efficiency can be improved and stray light can be reduced, thereby providing an objective lens optical system of high performance.

Fifthly, a step shape on a lens surface is applied to the above-described structure of changing a phase. With such a structure, a compatible technique can be provided without adding any new element for changing a phase, thereby reducing the size and weight of an objective lens optical system.

Sixthly, the above-described objective lens optical system is composed of one lens. Owing to such a structure, the compatible technique can be provided without adding any element for implementing compatibility, thereby reducing the size and weight of an objective lens optical system.

Specifically, according to one aspect of the present invention, there is provided an objective lens optical system focusing a light beam with a wavelength λ₁ on an information recording surface of a first optical recording medium including a transparent substrate with a thickness t1, a light beam with the wavelength λ₁ on an information recording surface of a second optical recording medium including a transparent substrate with a thickness t2 (t2≠t1), and a light beam with a wavelength λ₃ (λ₃≠λ₁) on an information recording surface of a third optical recording medium including a transparent substrate with a thickness t3 and having a positive power. The objective lens optical system comprises an area for the first optical recording medium, configured to focus the light beam with the wavelength λ₁ on the information recording surface of the first optical recording medium, without focusing the light beam with the wavelength λ₁ on the information recording surface of the second optical recording medium, and a common area configured to focus the light beam with the wavelength λ₁ on the information recording surface of the second optical recording medium, without focusing the light beam with the wavelength λ₁ on the information recording surface of the first optical recording medium, and to focus the light beam with the wavelength λ₃ on the information recording surface of the third optical recording medium, wherein, in the common area, an aspherical surface shape is designed to generate an aberration which substantially cancels out a chromatic aberration caused by a difference in wavelength λ of the light beam.

The objective lens optical system, wherein, in the common area, the aspherical surface is preferably designed in such a matter that a wavefront aberration caused by a difference in thickness of the transparent substrate of the optical recording medium, the chromatic aberration caused by the difference in wavelength λ of the light beam, and an aberration caused by the aspherical surface shape are substantially cancelled out each other.

It is preferred in the above objective lens optical system, wherein an optical path length difference between two common areas contiguously at inner and outer sides of the area for the first optical recording medium is greater than or equal to 0.5λ with respect to either one of the wavelength λ₁ and the wavelength λ₃.

It is preferred in the above objective lens optical system, wherein, the area for the first optical recording medium is provided in an area where a change of a wavefront aberration with respect to the second optical recording medium or the third optical recording medium is the largest when the common area is arranged in all area of one surface of an objective lens.

It is further preferred in the above objective lens optical system, wherein the thickness of the transparent substrate is |t3−t1|>|t3−t2|.

It is more preferred in the above objective lens optical system, wherein the common area is arranged at an outer portion in an NA area of the third optical recording medium.

With respect to the NA area herein, the inner side of the center of a corresponding aperture is called an inner area and the outer side thereof is called an outer area. As an incident angle to the lens surface is large in the outer area, it is difficult to remove aberration. However, by arranging a common area in such an outer area, promoting high performance can be achieved.

It is preferred in the above objective lens optical system, wherein the common area is sectioned into a plurality of sections in a radial direction from an optical axis.

It is further preferred in the above objective lens optical system, further comprising a common area configured to focus light on the information recording surfaces of the first optical recording medium and the third optical recording medium.

It is more preferred in the above objective lens optical system, wherein the objective lens optical system is applied to an optical pickup optical system.

According to another aspect of the present invention, there is provided an objective lens optical system focusing a light beam with a wavelength λ₁ on an information recording surface of a first optical recording medium including a transparent substrate with a thickness t1, a light beam with the wavelength λ₁ on an information recording surface of a second optical recording medium including a transparent substrate with a thickness t2 (t2≠t1), and a light beam with a wavelength λ₃ (λ₃≠λ₁) on an information recording surface of a third optical recording medium including a transparent substrate with a thickness t3 and having positive power. The objective lens optical system comprises an area for the first optical recording medium, configured to focus the light beam with the wavelength λ₁ on the information recording surface of the first optical recording medium, without focusing the light beam with the wavelength λ₁ on the information recording surface of the second optical recording medium, and a common area configured to focus the light beam with the wavelength λ₁ on the information recording surface of the second optical recording medium, without focusing the light beam with the wavelength λ₁ on the information recording surface of the first optical recording medium, and to focus the light beam with the wavelength λ₃ on the information recording surface of the third optical recording medium, wherein the light beam with the wavelength λ₃ and the light beam with the wavelength λ₁ enter the common area at different incident angles.

The objective lens optical system, wherein, in the common area, the aspherical surface is preferably designed in such a matter that a wavefront aberration caused by a difference in thickness of the transparent substrate of the optical recording medium, the chromatic aberration caused by the difference in wavelength λ of the light beam, and an aberration caused by the aspherical surface shape are substantially cancelled out each other.

It is preferred in the above objective lens optical system, wherein the thickness of the transparent substrate is |t3−t1|>|t3−t2|.

It is preferred in the above objective lens optical system, wherein an optical path length difference between two common areas contiguously at inner and outer sides of the area for the first optical recording medium is greater than or equal to 0.5λ with respect to either one of the wavelength λ₁ and the wavelength λ₃.

It is further preferred in the above objective lens optical system, wherein, the area for the first optical recording medium is provided in an area where a change of a wavefront aberration with respect to the second optical recording medium or the third optical recording medium is the largest when the common area is arranged in all area of one surface of an objective lens.

It is more preferred in the above objective lens optical system, wherein the objective lens optical system is applied to an optical pickup optical system.

According to another aspect of the present invention, there is provided an objective lens optical system focusing a light beam with a wavelength λ₁ on an information recording surface of a first optical recording medium including a transparent substrate with a thickness t1, a light beam with the wavelength λ₁ on an information recording surface of a second optical recording medium including a transparent substrate with a thickness t2 (t2≠t1), a light beam with a wavelength λ₃ (λ₃≠λ₁) on an information recording surface of a third optical recording medium including a transparent substrate with a thickness t3, and a light beam with a wavelength λ₄ (λ₄≠λ₁) on an information recording surface of a forth optical recording medium including a transparent substrate with a thickness t4 and having positive power. The objective lens optical system comprises an area for the first optical recording medium, configured to focus the light beam with the wavelength λ₁ on the information recording surface of the first optical recording medium, without focusing the light beam with the wavelength λ₁ on the information recording surface of the second optical recording medium, and a common area configured to focus the light beam with the wavelength λ₁ on the information recording surface of the second optical recording medium, without focusing the light beam with the wavelength λ₁ on the information recording surface of the first optical recording medium, to focus the light beam with the wavelength λ₃ on the information recording surface of the third optical recording medium, and to focus the light beam with the wavelength λ₄ on the information recording surface of the fourth optical recording medium, wherein the light beam with the wavelength λ₃ and the light beam with the wavelength λ₁ enter the common area at different incident angles, and in the common area, an aspherical surface shape is designed to mutually cancel out a chromatic aberration caused by a difference between the wavelength λ₄ and the wavelength λ₁ of the light beams.

The objective lens optical system, wherein, in the common area, the aspherical surface shape is preferably designed in such a matter that a wavefront aberration caused by a difference in thickness of the transparent substrates of the second optical recording medium and the fourth optical recording medium, the chromatic aberration caused by the difference between the wavelength λ₄ and the wavelength λ₁ of the light beams, and an aberration caused by the aspherical surface shape are substantially cancelled out each other.

It is preferred in the above objective lens optical system, wherein the thickness of the transparent substrate is |t3−t1|>|t3−t2| or/and |t4−t1|>|t4−t2|.

It is more preferred in the above objective lens optical system, wherein an optical path length difference between two common areas contiguously at inner and outer sides of the area for the first optical recording medium is greater than or equal to 0.5λ with respect to one of the wavelength λ₁, the wavelength λ₃, and the wavelength λ₄.

It is further preferred in the above objective lens optical system, wherein, the area for the first optical recording medium is provided in an area where a change of a wavefront aberration with respect to the second optical recording medium, the third optical recording medium, or the fourth optical recording medium is the largest when the common area is arranged in all area of an objective lens.

It is preferred in the above objective lens optical system, wherein the objective lens optical system is composed of one lens.

It is more preferred in the above objective lens optical system, wherein the objective lens optical system is applied to an optical pickup optical system.

In the present specification, although a laser wavelength corresponding to a first optical recording medium having a thickness t1 and a laser wavelength corresponding to a second optical recording medium having a thickness t2 are both represented as λ₁, it is not limited to using the same laser, but may be different lasers respectively. Therefore, λ₁ in this specification has some extent.

According to the present invention, it is possible to improve the light use efficiency and reduce stray light of an objective lens optical system in which wavelengths of light beams to be focused on at least two or more optical recording medium are the same, wavelengths of light beams to be focused on at least two or more optical recording medium are different, and light beam is focused on at least three or more optical recording medium, and thereby providing the objective lens optical system of high performance.

The above and other objects, features and advantages of the present invention will become more fully understood from the detailed description given hereinbelow and the accompanying drawings which are given by way of illustration only, and thus are not to be considered as limiting the present invention.

### BRIEF DESCRIPTION OF THE DRAWINGS

The objects, advantages, and features of the present invention will be apparent from the description in conjunction with the accompanying drawings, in which:

FIGS. 1A to 1D show schematic structure diagrams of an objective lens optical system according to Embodiment 1;

FIGS. 2A to 2D show wavefront aberrations of the objective lens optical system according to Embodiment 1;

FIGS. 3A to 3D show wavefront aberrations of the objective lens optical system according to Embodiment 2;

FIGS. 4A to 4D show wavefront aberrations of the objective lens optical system according to Embodiment 3;

FIGS. 5A to 5D show OPDs of an objective lens optical system according to Embodiment 3;

FIGS. 6A to 6D show wavefront aberrations of the objective lens optical system according to Embodiment 4;

FIGS. 7A to 7D show OPDs of an objective lens optical system according to Embodiment 4;

FIGS. 8A and 8B show typical wavefront aberrations for explaining cancellation of an aberration in an objective lens optical system according to Embodiment 4;

FIGS. 9A to 9D show wavefront aberrations of the objective lens optical system according to Embodiment 5;

FIGS. 10A to 10D show schematic structure diagrams of an objective lens optical system according to another Embodiment;

FIG. 11 is a table showing some values concerning optical recording medium which can be used in an objective lens optical system according to Embodiments;

FIG. 12 is a table showing effective apertures and refractive indexes of the objective lens optical system according to Embodiments 1 and 2;

FIG. 13 is a table showing characteristics of each area in the objective lens optical system according to the Embodiment 1;

FIG. 14 is a table showing lens data of the objective lens optical system according to Embodiment 1;

FIG. 15 is a table showing surface shape data (objective lens surface 1) of the objective lens optical system according to the Embodiment 1;

FIG. 16 is a table showing surface shape data (objective lens surface 2) of the objective lens optical system according to the Embodiment 1;

FIG. 17 is a table showing RMS wavefront aberration values of the objective lens optical system according to the Embodiment 1;

FIG. 18 is a table showing characteristics of each area in the objective lens optical system according to the Embodiment 2;

FIG. 19 is a table showing lens data of the objective lens optical system according to Embodiment 2;

FIG. 20 is a table showing surface shape data (objective lens surface 1) of the objective lens optical system according to the Embodiment 2;

FIG. 21 is a table showing surface shape data (objective lens surface 2) of the objective lens optical system according to the Embodiment 2;

FIG. 22 is a table showing RMS wavefront aberration values of the objective lens optical system according to the Embodiment 2

FIG. 23 is a table showing effective apertures and refractive indexes of the objective lens optical system according to Embodiments 3;

FIG. 24 is a table showing characteristics of each area in the objective lens optical system according to the Embodiment 3;

FIG. 25 is a table showing lens data of the objective lens optical system according to Embodiment 3;

FIG. 26 is a table showing surface shape data (objective lens surface 1) of the objective lens optical system according to the Embodiment 3;

FIG. 27 is a table showing surface shape data (objective lens surface 2) of the objective lens optical system according to the Embodiment 3;

FIG. 28 is a table showing RMS wavefront aberration values of the objective lens optical system according to the Embodiment 3;

FIG. 29 is a table showing effective apertures and refractive indexes of the objective lens optical system according to Embodiments 4;

FIG. 30 is a table showing characteristics of each area in the objective lens optical system according to the Embodiment 4;

FIG. 31 is a table showing lens data of the objective lens optical system according to Embodiment 4;

FIG. 32 is a table showing surface shape data (objective lens surface 1) of the objective lens optical system according to the Embodiment 4;

FIG. 33 is a table showing surface shape data (objective lens surface 2) of the objective lens optical system according to the Embodiment 4;

FIG. 34 is a table showing RMS wavefront aberration values of the objective lens optical system according to the Embodiment 4;

FIG. 35 is a table showing effective apertures and refractive indexes of the objective lens optical system according to Embodiment 5;

FIG. 36 is a table showing characteristics of each area in the objective lens optical system according to the Embodiment 5;

FIG. 37 is a table showing lens data of the objective lens optical system according to Embodiment 5;

FIG. 38 is a table showing surface shape data (objective lens surface 1) of the objective lens optical system according to the Embodiment 5;

FIG. 39 is a table showing surface shape data (objective lens surface 2) of the objective lens optical system according to the Embodiment 5; and

FIG. 40 is a table showing RMS wavefront aberration values of the objective lens optical system according to the Embodiment 5.

### DESCRIPTION OF THE PREFERRED EMBODIMENTS

An objective lens optical system according to Embodiments of the present invention described in detail below basically achieves compatibility of four types, that is BD (Blu-ray Disc), HDDVD (High Definition Digital Versatile Disc), CD (Compact Disc, including CD-R), and DVD (Digital Versatile Disc). Then, for achieving the compatibility of the four types, three degrees of freedom are required. As a result of searching a candidate of the degree of freedom, it has been found that the degree of freedom can be secured by the following three methods, and compatibility of the four types has been achieved by them.

(Method 1) method of sectioning an area (light beam) (corresponding to the compatible technique A above mentioned)

(Method 2) method using a high-order aspherical surface (corresponding to the compatible technique B above mentioned)

(Method 3) method using an incident angle

In addition, for achieving compatibility of three types, two of the three degrees of freedom mentioned above are sufficient to implement it. For example, in the case of achieving compatibility of three types of the HDDVD, BD, and DVD, although various combinations can be considered, the most practical is the combination of the compatible technique A and the compatible technique B. Besides, in the case of achieving compatibility of three types of the HDDVD, BD, and CD, various combinations can also be considered, but the most practical is the combination of Methods 1 and 3.

Furthermore, it has been examined which of the three methods is to be applied to the combination of the types to result in an optimal case.

First, a combination to which the method 1 should be applied has been examined. The method 1 of sectioning an area can be determined by selecting a combination to which the method 2 or the method 3 cannot be applied. It is impossible to apply the method 2 to the compatibility in the case of using the same wavelength, and the method 3 to the compatibility in the case of using the same laser light source. Then, since the BD and HDDVD use the same blue wavelength (408 nm or 405 nm), the method 2 cannot be applied to them. Moreover, if two lasers are used in the case of the same wavelength, it results in increasing the cost and the number of parts of the optical pick optical system. Therefore, it is preferable to use the same laser, and in that case, the method 3 cannot be applied. Consequently, it is concluded to apply the method 1 to the combination of the BD and HDDVD. Then, although sectioning the area could be selected from the range of sectioning it into two to sectioning it into four, since the light use efficiency decreases in proportion as the number of sectioning increases, sectioning into two areas is selected. In addition, for making the optical system small by securing a working distance of CD, it is also acceptable to perform sectioning into three by preparing an exclusive area for CD.

Next, a combination to which the methods 2 and 3 are to be applied has been examined from two viewpoints of the aberration performance and the light use efficiency. According to the method 2, as has been explained in the compatible technique B, the compatibility can be achieved by cancelling the aberration a by the aberrations β and γ.

Achieving compatibility between a medium using a blue wavelength (BD or HDDVD) and a CD by using the method 2 is examined first. Assuming that an optical path length difference with respect to a light beam of a blue wavelength is OPD_{Blue}=2λ_{Blue} (λ_{Blue} herein is a wavelength of a light beam of a blue wavelength), and determining an optical path length difference to be insensitive to the light beam of the blue wavelength, as an optical path length difference OPD_{CD} with respect to a light beam of a CD is d(n_{Blue}−1)×2×405 nm, it becomes 0.9913λ_{CD} (λ_{CD} herein is a wavelength of a light beam of a CD) as the following formula.
OPD_{CD}=d(n_{CD}−1)=(n_{CD}−1)/(n_{Blue}−1)×2×405 nm/790 nm=0.9913λ_{CD}

where d denotes a step, n_{Blue} denotes a refractive index with respect to a light beam of a blue wavelength, n_{CD} denotes a refractive index with respect to a light beam of a CD, and the values shown in FIG. 23 are used.

Considering the aberration, since one step can generate an aberration of only 9mλ_{CD} ( 1/13 of the case of DVD), if the number of steps is not increased, it is impossible to generate a desired aberration. Then, however, if the number of steps is increased, scattering occurs at the step part, which results in problems, such as a lowering of the light use efficiency, generation of stray light, and further, being difficult to precisely process. Therefore, it is not appropriate to make compatibility between the medium using a blue wavelength (BD or HDDVD) and CD by using the method 2.

On the other hand, while the difference of the substrate thickness between BD and CD is 1.1 mm, the one between HDDVD and CD is only 0.6 mm. Therefore, it is preferable to achieve compatibility between the HDDVD and CD to reduce an incident angle difference and prevent a lowering of the lens shift characteristics caused by an increase of the incident angle. For example, when an infinite system is employed for HDDVD and a finite system is employed for CD, the aberrations α and β can be compensated even when the incident angle difference is small. Thus, it is basically optimal to achieve the compatibility between HDDVD and CD by using the method 3.

It has so far been concluded that it is the most appropriate to achieve the compatibility between the BD and HDDVD by using the method 1, and the compatibility between the CD and HDDVD by using the method 3.

With respect to DVD, it is possible to make compatibility with HDDVD by using the method 2. Although providing compatibility between DVD and BD can also be considered, since a difference of the substrate thickness between DVD and HDDVD is smaller than that of between DVD and BD, it is optimal to provide compatibility between DVD and HDDVD by using the method 3.

Thus, it has been found that using an exclusive area for BD, and a common area for the other HDDVD, CD, and DVD is the most appropriate compatible state for the four types.

Now, examining is also performed from a viewpoint of the light use efficiency. According to the method of sectioning a light beam, a focal length of each area can be arbitrarily set up. Therefore, it is possible to arbitrarily specify an effective aperture. Since a medium of a blue wavelength (BD or HDDVD) uses one laser because of the reason stated above, it is necessary to section the light beam. However, since DVD and CD use exclusive lasers respectively in many cases, sectioning the light beam is ultimately unnecessary. For example, the case will be considered that sectioning is performed for the exclusive area for BD and the common area of three wavelengths of the HDDVD, DVD, and CD. It is sectioned into two to have an area ratio to the light beam of BD and HDDVD using a blue laser to be 50% and 50%. At this time, the relation of respective effective apertures Φ_{BD} and Φ_{HD} is as follows
Φ_{BD}²×π−Φ_{HD}²π:Φ_{HD}²×π=1:1

Therefore, it becomes 2×Φ_{HD}²=Φ_{BD}²

The area for HDDVD is arranged at the inner are, and the exclusive area for BD is arranged at the outer side thereof. Assuming that a necessary NA is 0.85 and 0.65 respectively, since the effective aperture is represented as Φ=2×f×NA according to the paraxial theory, it can be achieved by configuring respective focal length to be f_{BD}:f_{HD}=Φ_{BD}/1.7:Φ_{HD}/1.3 ≈0.924:1. At this time, since the DVD and CD are formed in the common area to be used with HD, the area in the Φ_{H} is used. For this reason, it becomes possible for the DVD laser and the CD laser to input a laser beam into respective effective apertures, the area of 100% to the light beam can be used. That is, the use areas 50%, 50%, 100%, and 100% of the BD, HD, DVD and CD can be realized.

Moreover, with a structure in which sectioning is performed for the exclusive area for the HD and the common area for the BD, DVD, and CD, it is also possible to achieve the light beam sectioning of the use areas 50%, 50%, 100%, and 100% of BD, HD, DVD and CD as well as the above. Examining the compatible method described above, to use the former structure is the most appropriate. Moreover, although sectioning into two is preferable from the viewpoint of the use area, with considering a light beam interference and a working distance, the exclusive area for BD is allocated in the common area.

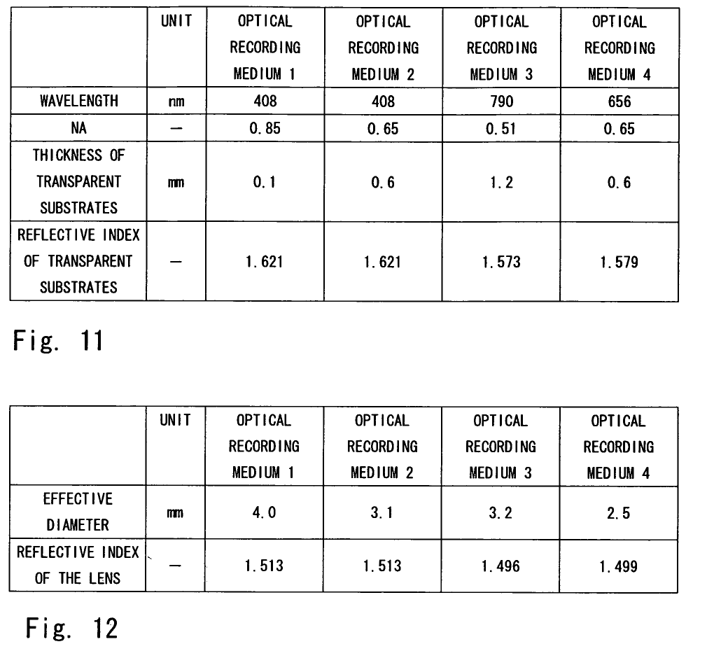

The objective lens optical system according to the present Embodiment has a structure capable of focusing light on the four types of the optical recording medium specified by FIG. 11. Specifically, the optical recording medium 1 is a BD, the optical recording medium 2 is a HDDVD, the optical recording medium 3 is a CD, and the optical recording medium 4 is a DVD. As shown in the figure, the wavelengths of the light beams to be focused are the same with respect to the optical recording medium 1 and 2.

In contrast to the optical recording medium 1 and 2, the wavelengths of the light beams to be focused are different with respect to the optical recording medium 3 and 4. Moreover, the wavelengths of the light beams to be focused are different each other between the optical recording medium 3 and 4. Furthermore, although the thicknesses of the transparent substrates of the optical recording medium 2 and 4 are the same, they are different from those of the optical recording medium 1 and 3. Moreover, the thicknesses of the transparent substrates are different each other between the optical recording medium 1 and 3.

### Embodiment 1

The objective lens optical system according to the present Embodiment 1 is composed of one lens. With respect to this objective lens, an effective aperture of an incident light beam into each of the optical recording medium and a refractive index of lens material used are shown in FIG. 12.

FIG. 13 shows areas of light height for focusing light on each of the optical recording medium. The number for each area will be hereinafter called a “medium area number.” For example, a medium area number 1 is an area specified by a light height of 0 to 0.232 mm, and a medium area number 2 is an area specified by a light height of 0.232 to 0.725 mm. The light height is a distance from an optical axis which is perpendicular to an optical axis on the iris surface.

According to Embodiment 1, as shown in FIG. 13, focusing light on each of the optical recording medium shown in FIG. 13 can be performed in the area specified by the medium area number. Concretely, the area specified by the medium area number 1 is a common area capable of focusing light on all the optical recording medium 1, 2, 3, and 4. Each of the areas specified by the medium area numbers 3 and 5 is an exclusive area for the optical recording medium 2, which is capable of focusing light only on the optical recording medium 2. Each of the areas specified by the medium area numbers 2 and 4 is a common area capable of focusing light on the optical recording medium 1, 3, and 4, and the area specified by the medium area number 6 is a common area capable of focusing light on the optical recording medium 1 and 4. The area specified by the medium area number 7 is an exclusive area capable of focusing light on the optical recording medium 1.

Thus, according to Embodiment 1, the optical recording medium 1 and 2, which have the same wavelength and different substrate thickness, basically use different areas except for the area specified by the medium area number 1. Compatibility between the optical recording medium 1 and 2 can be provided by using the compatible technique A described above. With respect to the optical recording medium 1, 3, and 4, compatibility among them can be provided by using the compatible technique B described above.

Moreover, as shown in FIG. 13, the areas specified by the medium area numbers 1 to 4 correspond to the NA of the optical recording medium 3, the areas specified by the medium area numbers 1 to 5 correspond to the NA of the optical recording medium 2, the areas specified by the medium area numbers 1 to 6 correspond to the NA of the optical recording medium 4, and the areas specified by the medium area numbers 1 to 7 correspond to the NA of the optical recording medium 1.

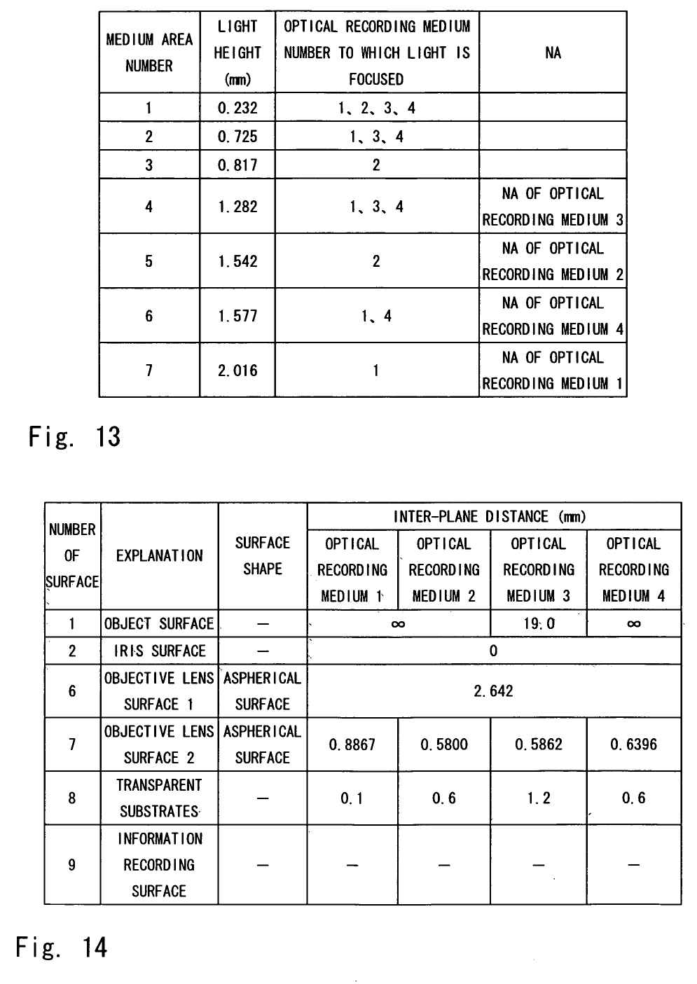

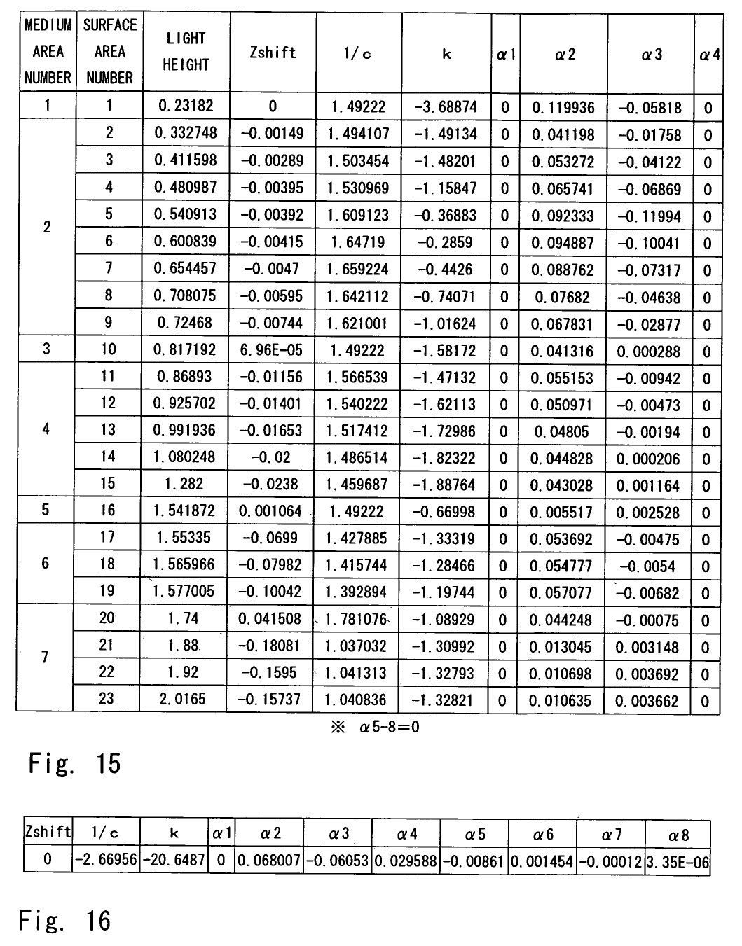

FIGS. 14 and 15 show lens data and surface shape data of the lens of the objective lens optical system according to the present Embodiment 1. The surface shape data shown in FIG. 15 is expressed by the following formula (1). In an objective lens surface 1, medium area sectioning and surface area sectioning are performed by using an aspherical surface coefficient up to the 6th order, and each surface area is formed in the shape of steps. An aspherical surface coefficient up to the 16th order is used for an objective lens surface 2.

$$z = Zshift + \frac{{cr}^{2}}{1 + \sqrt{1 - ( 1 + k ) {c}^{2} {r}^{2}}} + {α}_{1} {r}^{2} + {α}_{2} {r}^{4} + {α}_{3} {r}^{6} + {α}_{4} {r}^{8} + ⋯ \qquad [ Formula ( 1 ) ]$$

where z denotes an aspherical sag amount and indicates a distance of the aspherical surface from a tangent plane on the optical axis at the coordinates point on the aspherical surface whose height from the optical axis is r. k denotes a Korenich constant (coefficient). c denotes a curvature (1/radius of curvature) of the aspherical surface on the optical axis. r denotes a light height from the optical axis. Each of α_{1, 2}, . . . denotes an aspherical surface coefficient. Zshift indicates an amount of deviation of the optical axis intersection in the case of forming each surface area to be up to the optical axis.

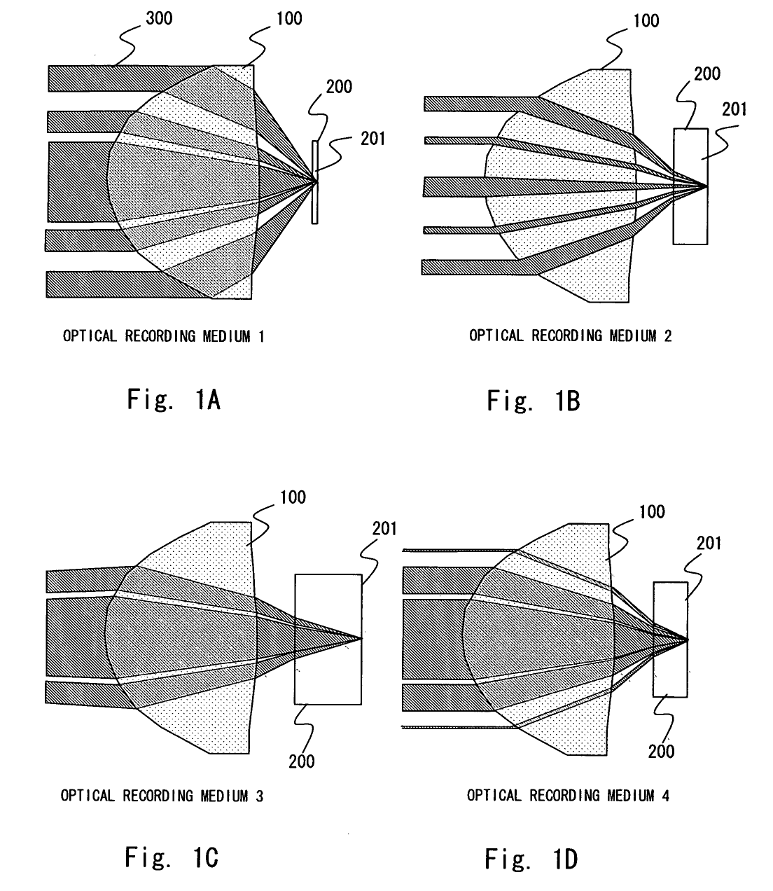

Next, an outline of the structure of the objective lens optical system according to Embodiment 1 will be described with reference to FIG. 1. In the figure, the reference numeral 100 denotes an objective lens, 200 denotes an optical recording medium (transparent substrate), 201 denotes an information recording surface, and 300 denotes a light beam. The objective lens 100 is used in common to the optical recording medium 1 to 4. In FIGS. 1A to 1D, the light beam 300 indicates merely a light beam to be focused on the information recording surface 201 of each optical recording medium 200.

As apparent from FIGS. 1A and 1B, it is designed at the plane of incidence of the objective lens 100 so that the area for focusing light on the optical recording medium 1 and the area for focusing light on the optical recording medium 2 may not overlap each other except for a certain area (the central area, in this example). This is because the wavelengths of the light beams used for the optical recording medium 1 and 2 are the same but the thicknesses of the transparent substrates of them are different, the compatible technique B which utilizes a wavelength difference cannot be used for them, thereby using the compatible technique A which sections the area.

Moreover, as apparent from FIGS. 1A, 1C, and 1D, at the plane of incidence of the objective lens 100, the area for focusing light on the optical recording medium 1, the area for focusing light on the optical recording medium 3, and the area for focusing light on the optical recording medium 4 are basically in accordance with each other. However, as shown in FIGS. 11 and 12, since NAs and lens effective apertures of the optical recording medium 1, 3, and 4 are different each other, the above areas do not overlap each other near the periphery.

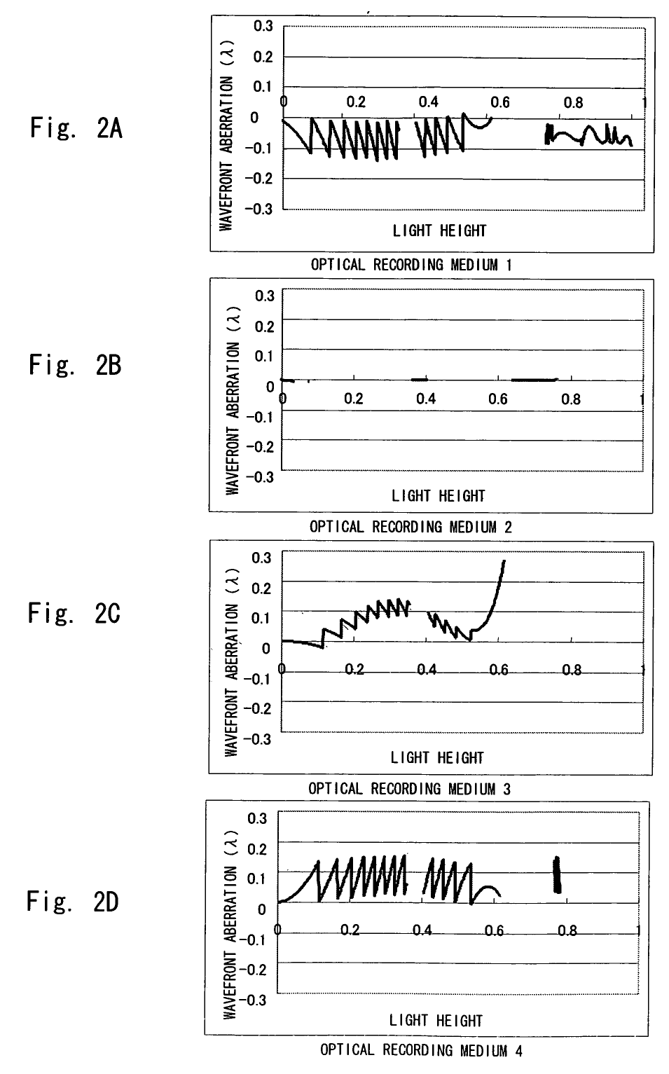

FIG. 2 shows wavefront aberrations of the objective lens optical system according to Embodiment 1. FIGS. 2A, 2B, 2C, and 2D respectively show wavefront aberrations with respect to the optical recording medium 1, 2, 3, and 4. The solid lines indicating wavefront aberrations in the illustration of FIG. 2 are drawn only for the areas for focusing light on each of the optical recording medium in FIG. 13.

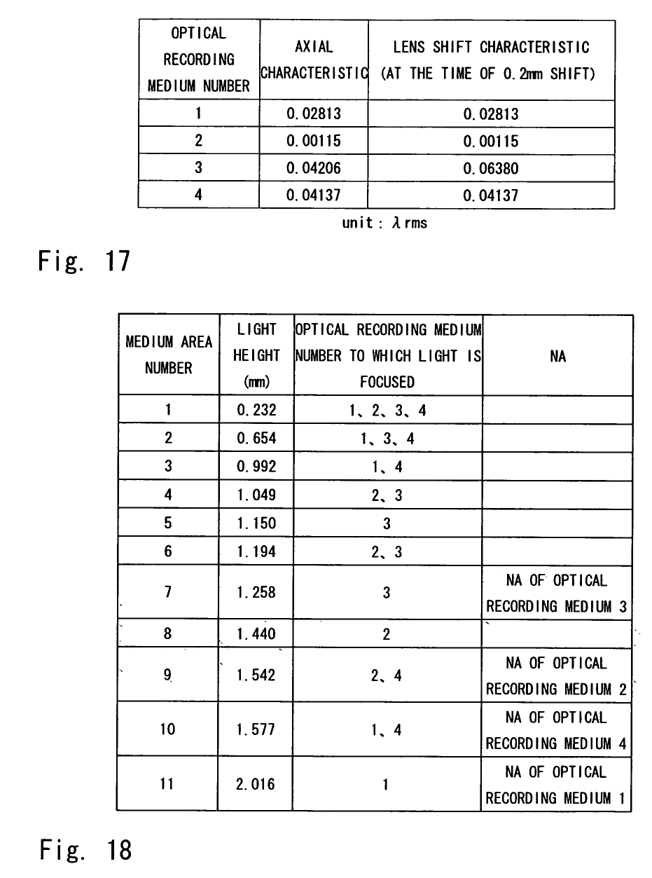

FIG. 17 shows an RMS (Root Mean Square) wavefront aberration value in the area for focusing light on each of the optical recording medium in FIG. 13. As shown in the axial characteristic in the figure, the RMS wavefront aberrations in the objective lens optical system according to Embodiment 1 are less than or equal to 0.05λ with respect to all the optical recording medium, thereby achieving the Marechal limit. Moreover, the lens shift characteristic of a CD having a finite system is 0.06380, which achieves to be less than or equal to 0.07λ.

As shown in FIGS. 2 and 14, with respect to the optical recording medium 1 and 2 using the same wavelength, by respectively arranging an independent medium area, it becomes possible to provide an objective lens optical system capable of focusing light on the two optical recording medium.

As shown in FIGS. 2, 15, and 16, in the areas of the medium region numbers 2, 4, and 6, which provide compatibility of the optical recording medium using different wavelengths, the compatible technique B is used in which a phase is changed so that an aberration of a focusing point on the information recording surface with respect to an arbitrary light height may be within an allowable range, thereby focuses light by using a refraction action. Further, with respect to the optical recording medium 3, in addition to using the compatible technique B, light is focused by a refraction action of correcting a spherical aberration by using a distance of an object surface. Accordingly, it becomes possible to provide an objective lens optical system capable of focusing light on different information recording surfaces without causing lowering of the light use efficiency due to the diffraction efficiency, unlike the compatible technique by a diffractive structure.

Moreover, as shown in FIGS. 14, 15, and 16, since the structure of changing a phase is realized by a step shape on the lens surface, it is not necessary to newly employ a structure for changing a phase, thereby providing a small and lightweight objective lens optical system.

As explained above, since the compatible technique of sectioning an area is applied to optical recording medium using the same wavelengths, and the compatible technique by a refraction action using the structure in which a phase is changed in the same area is applied to optical recording medium using different wavelengths, it becomes possible to provide an objective lens optical system of high performance.

### Embodiment 2

The objective lens optical system according to the present Embodiment 2 has the same basic structure as that of Embodiment 1, in which light is focused on the four types of the optical recording medium shown in FIG. 11, and a lens material is used which has the effective apertures and the refractive indexes of an incident light beam to be input into each of the optical recording medium shown in FIG. 12. Hereafter, description is omitted for the same contents as those of Embodiment 1.

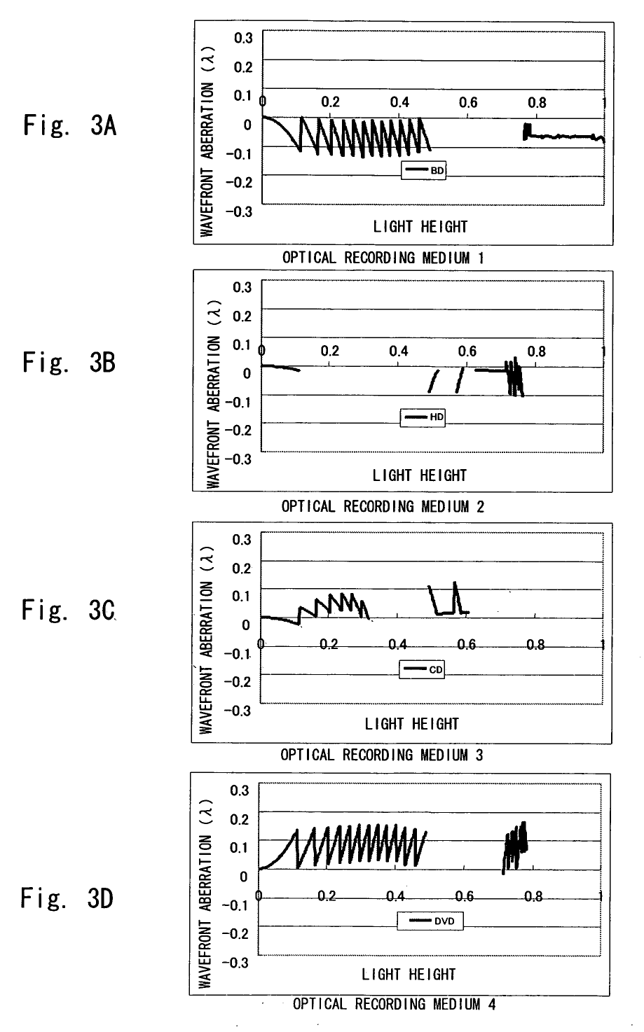

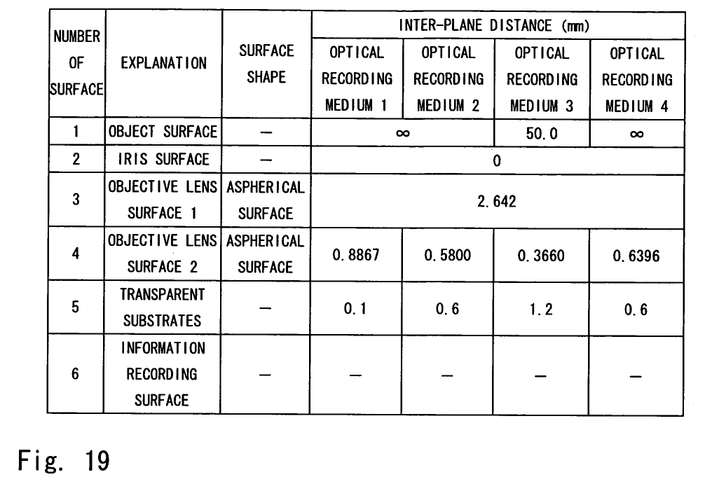

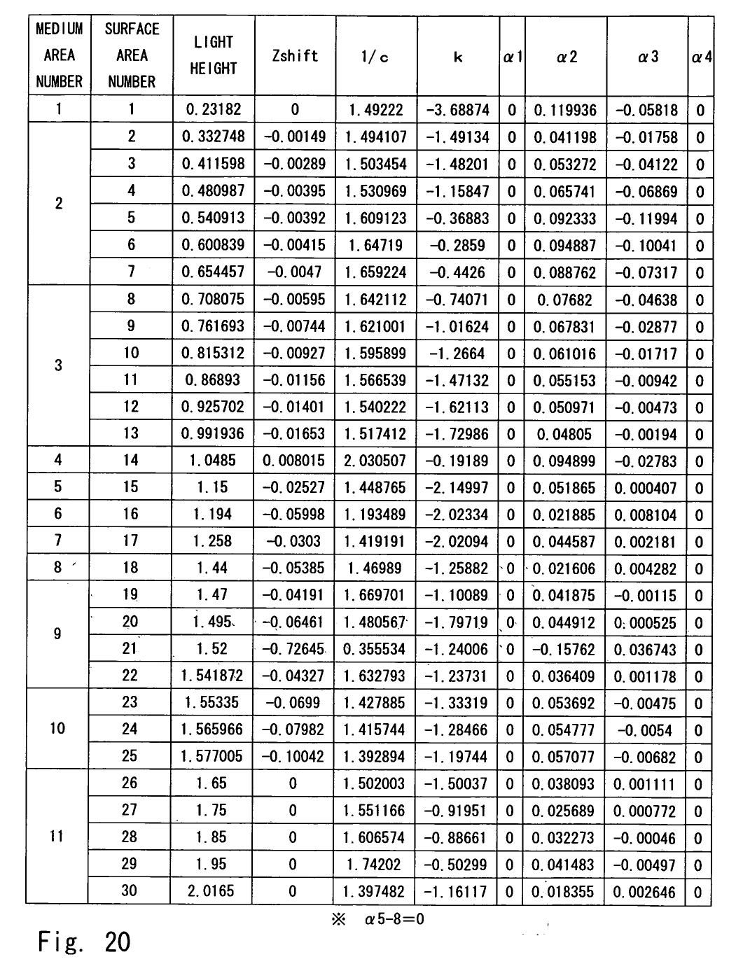

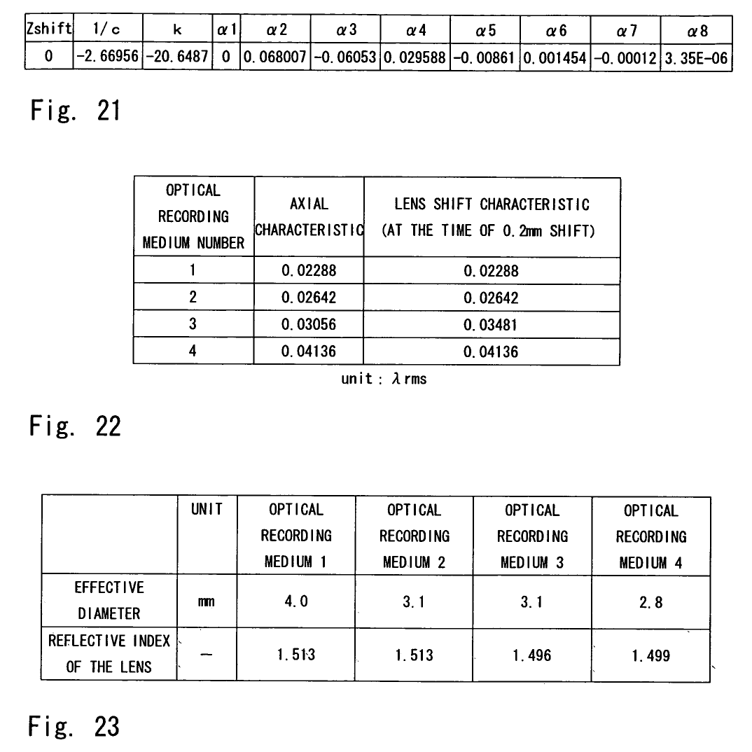

FIG. 18 shows areas of light height for focusing light on each of the optical recording medium in the objective lens optical system according to Embodiment 2. FIGS. 19 and 20 show lens data and surface shape data of the lens of the objective lens optical system according to Embodiment 2. FIG. 3 shows wavefront aberrations of the objective lens optical system according to Embodiment 2, and FIG. 22 shows an RMS wavefront aberration value concerning the objective lens optical system according to Embodiment 2. As shown in the axial characteristic in the figure, the RMS wavefront aberrations in the objective lens optical system according to Embodiment 2 are less than or equal to 0.05λ with respect to all the optical recording medium, thereby achieving the Marechal limit. Moreover, the lens shift characteristic achieves to be less than or equal to 0.05λ.

According to the above Embodiment 1, as shown in FIG. 13, compatibility between the optical recording medium 3 and 1 is achieved in the area specified by the medium area number 4 and corresponding to the NA part of the optical recording medium 3. On the other hand, according to the present Embodiment 2, as shown in FIG. 18, compatibility between the optical recording medium 3 and 2 is achieved in the area specified by the medium area numbers 4 and 6 and corresponding to the NA part of the optical recording medium 3. Owing to such a structure, the object distance with respect to the optical recording medium 3 being a finite system can be extended as shown in FIG. 19, and the RMS wavefront aberration value (especially, the lens shift characteristic) with respect to the optical recording medium 3 can be improved as shown in FIG. 22. This is because the wavefront aberration caused by a difference between the transparent substrate thickness (0.6 mm) of the optical recording medium 2 and the transparent substrate thickness (1.2 mm) of the optical recording medium 3 is smaller than the wavefront aberration caused by a difference between the transparent substrate thickness (0.1 mm) of the optical recording medium 1 and the transparent substrate thickness (1.2 mm) of the optical recording medium 3, it becomes possible to improve the performance by achieving compatibility based on a combination of small wavefront aberrations generated due to a difference of the substrate thickness, in the neighborhood of the NA where it is difficult to improve the aberration. According to the present Embodiment, the performance of lens shift is improved, and it is also preferable to enhance other performance using the present compatible technique.

Moreover, it is apparent that the same effect as that of Embodiment 1 can also be acquired simultaneously in the present Embodiment.

The principle of the compatible technique B, which has been concretely specified in the Embodiments 1 and 2, will now be described in detail in Embodiments 3 and 4.

### Embodiment 3

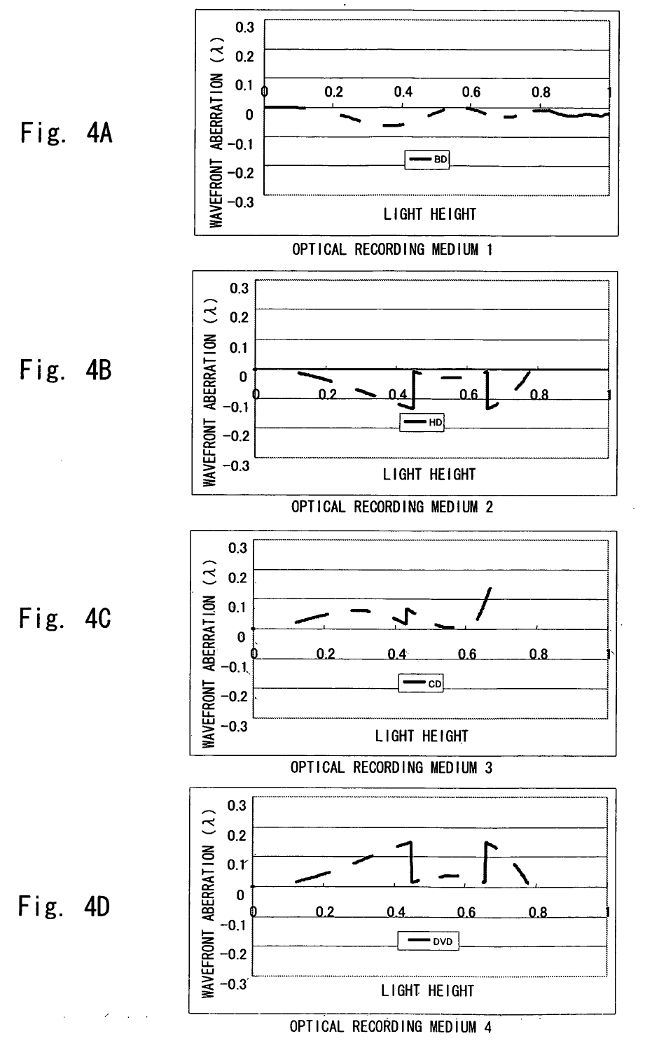

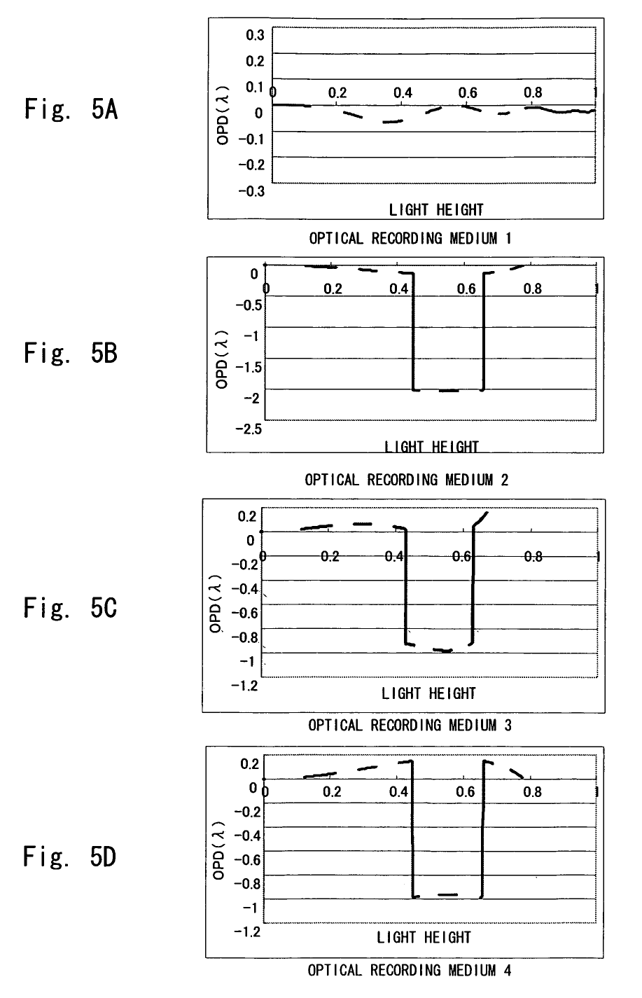

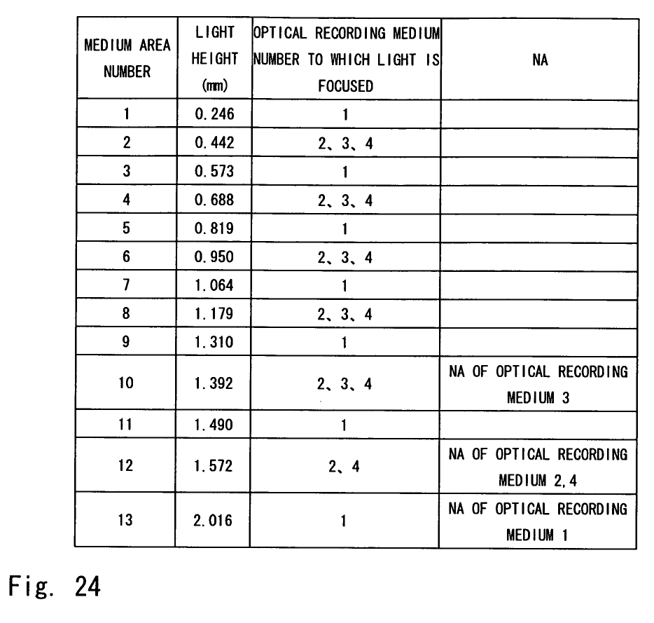

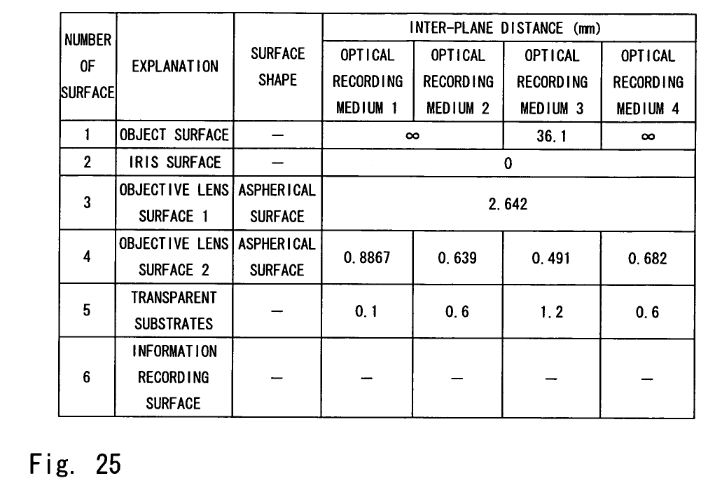

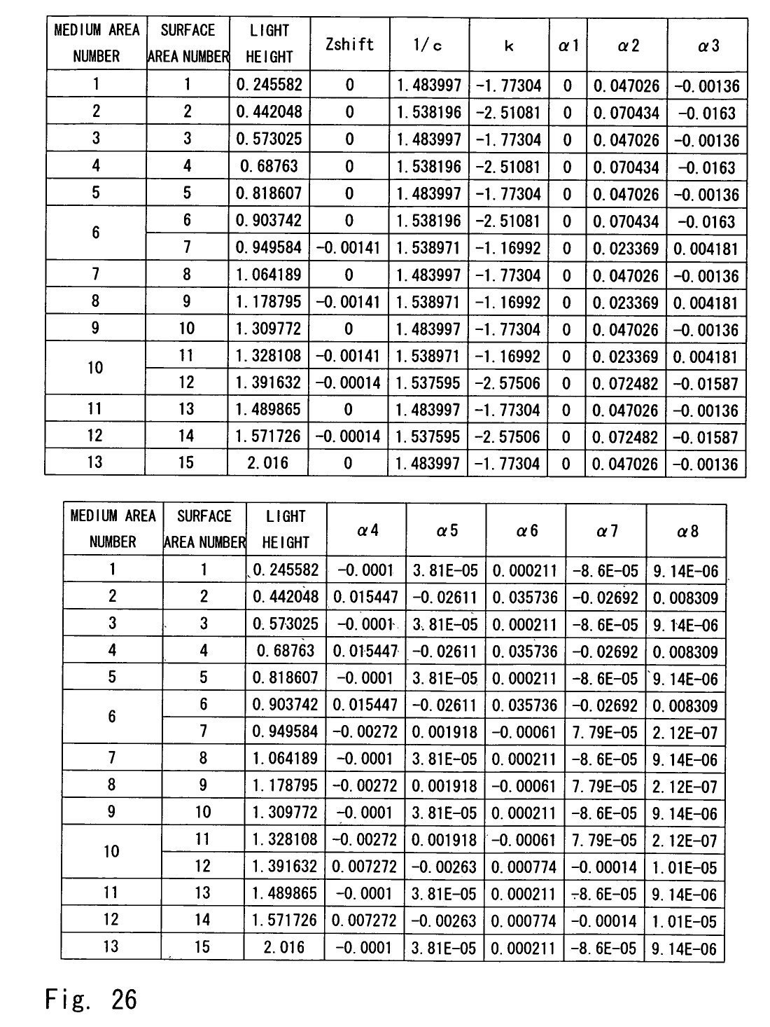

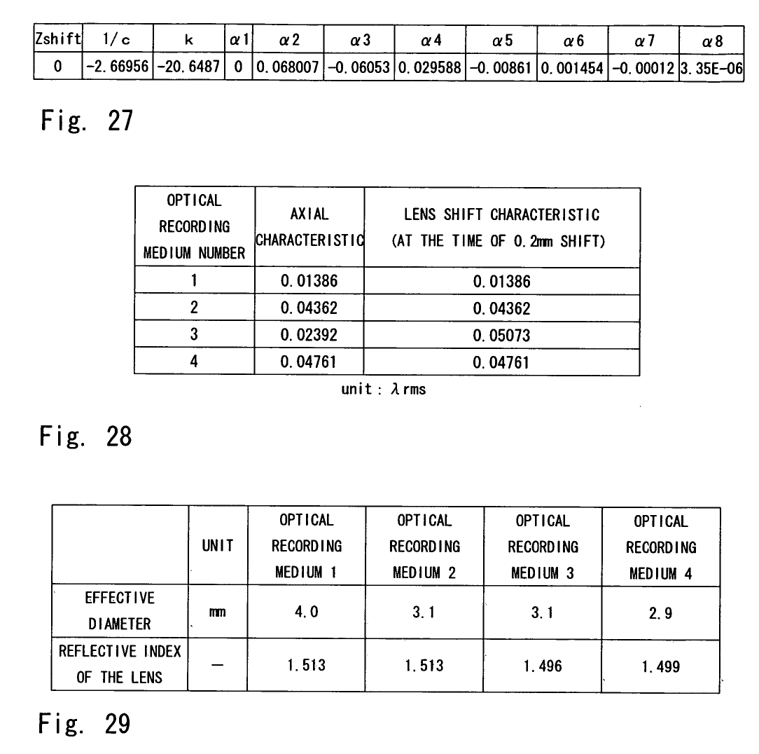

According to Embodiment 3 described below, the objective lens optical system of the present Embodiment has the same basic structure as that of Embodiment 1, in which light is focused on the four types of the optical recording medium by using the objective lens optical system shown in FIGS. 23-27. FIG. 4 shows features of the objective lens optical system according to Embodiment 3, and FIG. 28 shows RMS wavefront aberration values. Hereafter, the description is omitted for the same contents as those of Embodiment 1.

In the objective lens optical system according to Embodiment 3, an optical path length difference between areas is arranged as follows: That is, with respect to the areas specified by the surface area numbers 2, 4, 6, 12, and 14, an optical path length difference is set to be approximately −0.06±0.06λ, that is −0.12λ₂ to 0λ₂ for the optical recording medium 2, and an optical path length difference is set to be approximately +0.06±0.06λ, that is 0λ₄ to 0.12λ₄ for the optical recording medium 4. Moreover, with respect to the areas specified by the surface area numbers 7, 9, and 11, an optical path length difference is set to be approximately −2.06±0.06λ, that is −2.12λ₂ to −2λ₂ for the optical recording medium 2, and an optical path length difference is set to be approximately −0.94±0.06λ, that is −1λ₄ to 0.88λ₄ for the optical recording medium 4. Thus, by setting the optical path length difference as stated above, compatibility between the optical recording medium 2 and 4 is achieved by the compatible technique B.

In the objective lens optical system according to the present Embodiment 3, compatibility between the optical recording medium 2 and 3 is achieved in the medium area of the NA part of the optical recording medium 3 as well as Embodiment 2. Furthermore, although compatibility between the optical recording medium 1 and 4 is achieved in the medium area of the NA part of the optical recording medium 4 in Embodiments 1 and 2, compatibility between the optical recording medium 2 and 4 is now achieved in the medium area of the NA part of the optical recording medium 4. Owing to such a structure, as shown in FIG. 28, the lens shift characteristic can be improved compared with Embodiment 1, and both the axial characteristic and the lens shift characteristic can be controlled to be less than or equal to 0.06λ, thereby providing an objective lens optical system of high performance.

With respect to both the optical recording medium 3 and 4, whose wavelengths are different from those of the optical recording medium 1 and 2, compatibility is achieved with the optical recording medium 2 concerning which the difference of the substrate thickness is small. Consequently, it becomes possible to reduce the number of the surface areas, which results in reducing the steps formed between the surface areas, thereby enabling to be manufactured easily and attaining high performance by suppressing the light scattering caused by the steps.

However, in order to further enhance the characteristics concerning the wavefront aberration, it has been found as a result of research conducted by the inventors that there is a need to devise the setting of the exclusive area and the common area as described below in the following Embodiment.

### Embodiment 4

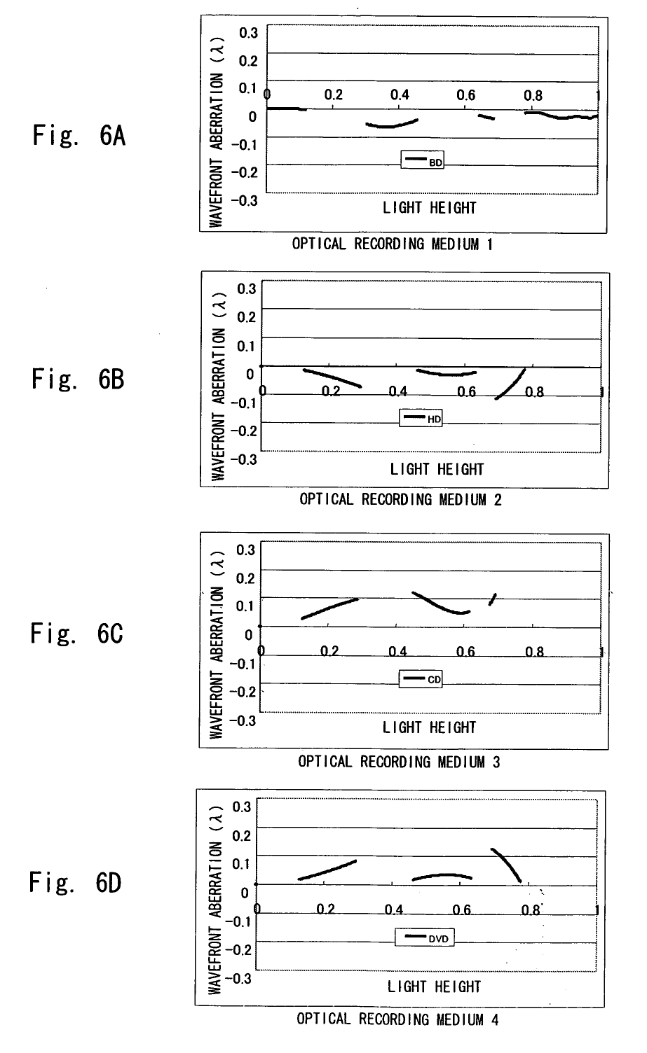

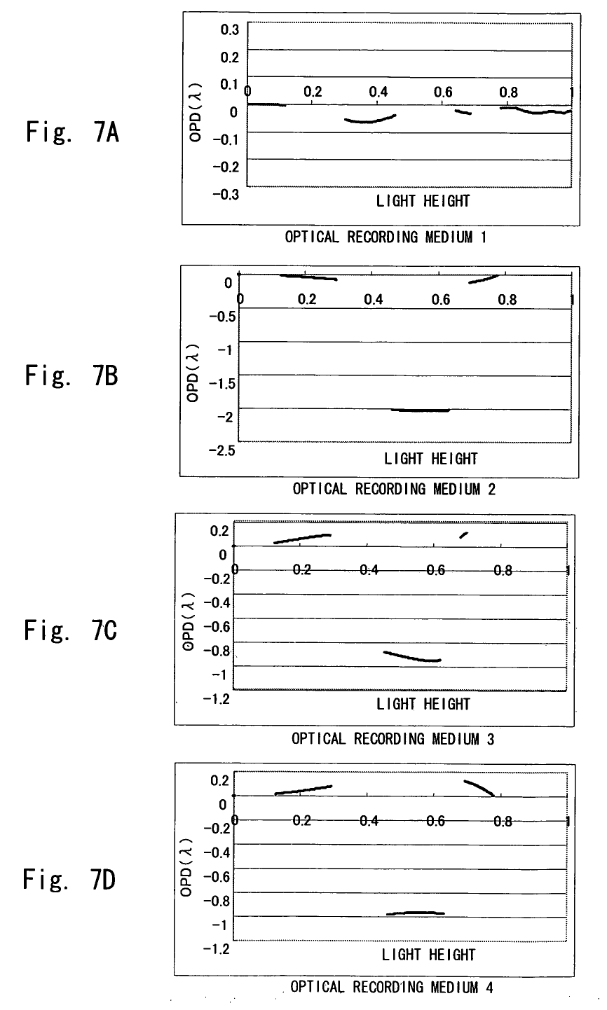

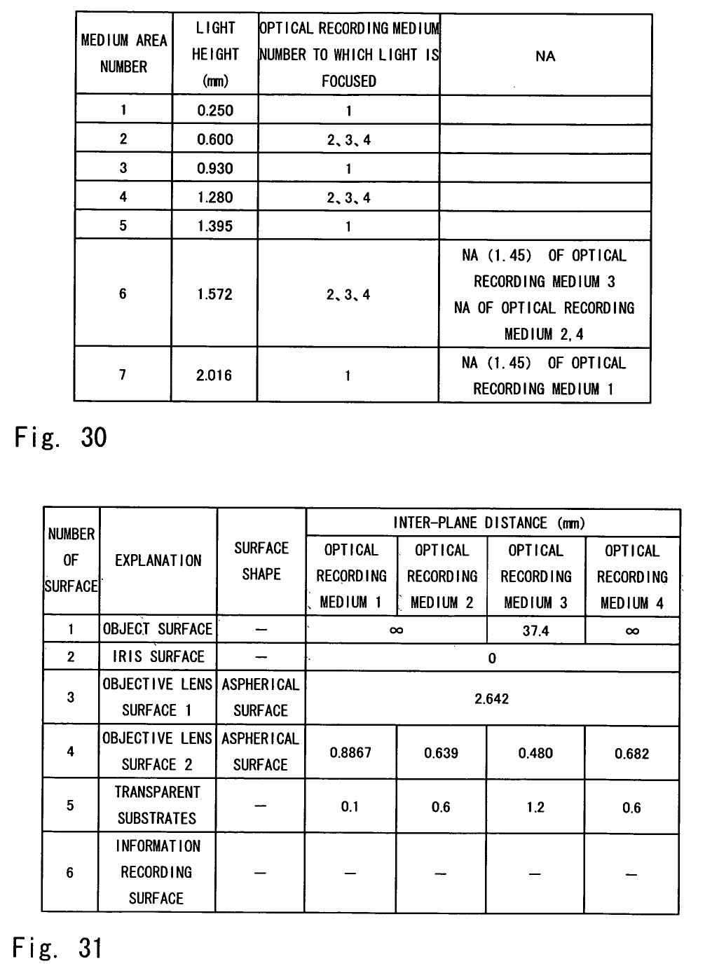

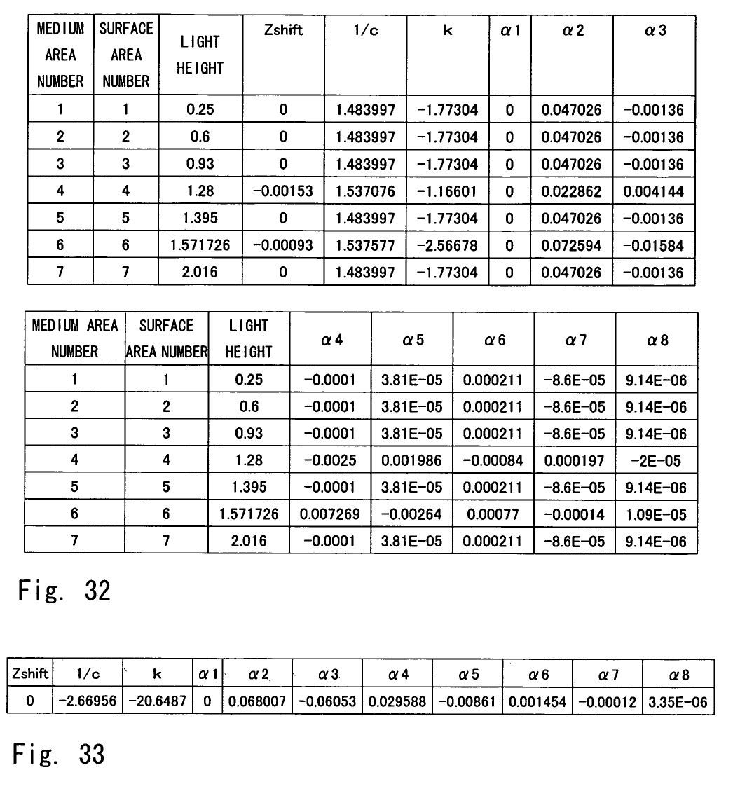

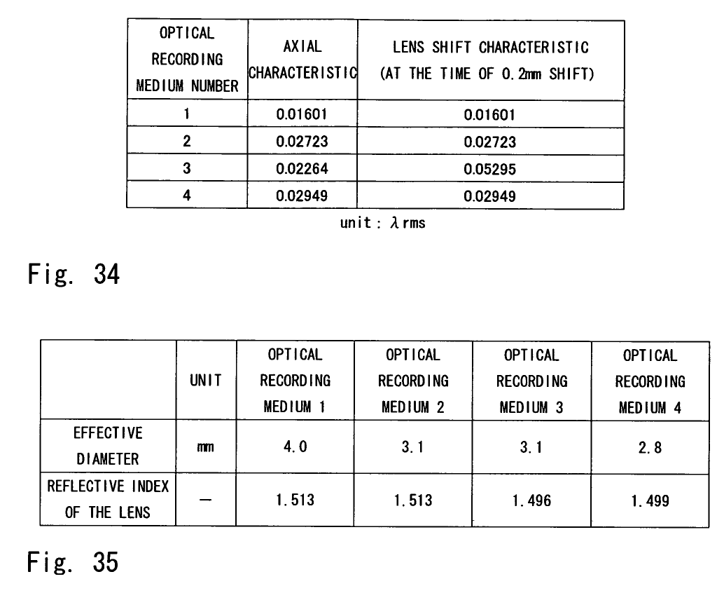

The objective lens optical system according to the present Embodiment 4 has the same structure as that of Embodiment 3, in which light is focused on the four optical recording medium by using the objective lens optical system shown in FIGS. 29 to 33. FIGS. 6 and 7 show features of the objective lens optical system, and FIG. 34 shows RMS wavefront aberration values.

In the objective lens optical system according to Embodiment 4, the lens shape of the area for focusing light on the optical recording medium 1 and the lens shape of the area for focusing light on the optical recording medium 2, 3, and 4 are the same as those of Embodiment 3, and however, only the position of sectioning has been changed. As shown in FIG. 30, the medium area numbers 1, 3, 5, and 7 are exclusive areas for the optical recording medium 1, and the medium area numbers 2, 4, and 6 are common areas for the optical recording medium 2, 3, and 4.

In Embodiment 4 as well as Embodiment 3, the compatible technique B is used for achieving the compatibility between the optical recording medium 2 and 4. In the step part according to the compatible technique B, an optical path length difference OPD expressed by the formula (2) is generated.
OPD=d(N−N₀)/λ [Formula (2)]

where d denotes the amount of steps, N denotes a refractive index of a material constituting the steps, and NO denotes a refractive index of air.

As one of realizing methods of the compatible technique B, there is a technique of cancelling the aberrations α, β, and γ, or a technique of cancelling the aberrations β, and γ in each optical recording medium (each wavelength), by generating the aberration γ by using mod (OPD)−1 in the case of the mod (OPD)>0.5 and by using mod (OPD) (hereinafter this value will be called W) in the case of the mod (OPD)<0.5. The mod herein means subtracting a maximum integer, which does not exceed the value of OPD, from the OPD. For example, in the case of OPD=−1.9, it will be mod (OPD)=0.1 and W=0.1, and in the case of OPD=1.6, it will be mod (OPD)=0.6 and W=−0.4.

In this case, since W obtained from the step increases depending on a combination of materials constituting the wavelength and the step, there have been problems that an optical performance is deteriorated because of a jump of a wavefront aberration generated at the step, the manufacturing becomes difficult because of an increase in the step amount, and an optical performance is deteriorated because of an increase of stray light at the step part. Conversely, when W is small, the aberration γ generated at one step by the compatible technique B becomes small. Therefore, many steps are needed to achieve the cancellation. Accordingly, there have been problems that manufacturing becomes difficult because of the large number of the steps, and an optical performance is deteriorated because of an increase of the stray light at the step part.

From such a viewpoint, in each of Embodiments 3, 4, and 5, a phase difference given to the optical recording medium 1 or 2, and the optical recording medium 4 is made to satisfy the following based on the formula (2).
|W2−W4|≈0.24λ
where W2 is W of the optical recording medium 1 or 2, and W4 is W of the optical recording medium 4.

At this time, 0.24λ is distributed to the optical recording medium 1 or 2, and the optical recording medium 4 in order to have high performance for both of them, and the aberration γ between W2±0.12λ and W4=−0.12λ is made to be generated at one step.

Consequently, according to Embodiment 3, it is possible to approximately realize OPD2=−2nλ+0.12 and OPD4=−nλ−0.12λ, and the cancellation of the aberrations α, β, and γ, or the cancellation of the aberrations β and γ is achieved.

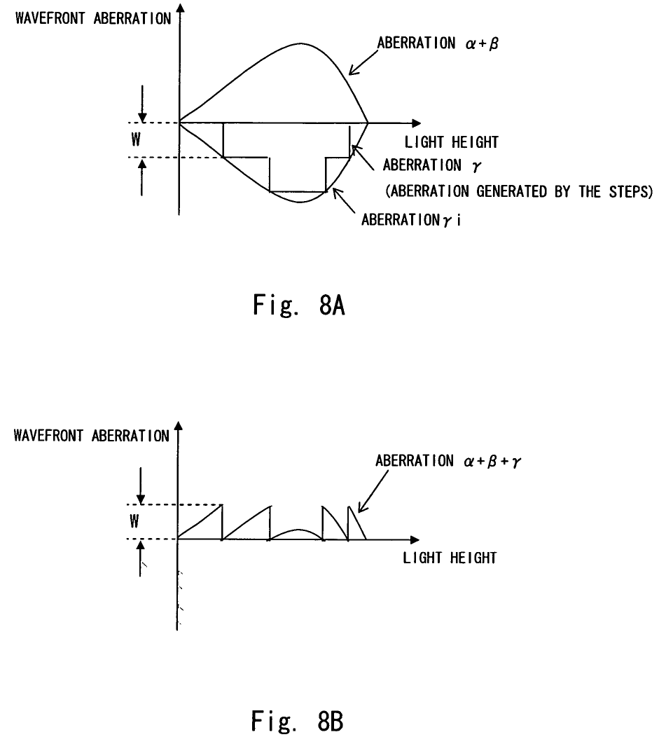

In this case, as shown in the schematic diagram of FIG. 8, the sum of the aberration α and the aberration β usually becomes a curving line. Then, in order to cancel this, it needs to have a curving line as shown by an aberration γi. However, as mentioned above, since the aberration γ is generated by the steps being provided, the actual aberration γ is an aberration in the shape of steps. Accordingly, it becomes an important factor for reducing the amount of wavefront aberrations and achieving high performance how to reduce the aberration amount W generated by one step.

Then, according to present Embodiment 4, a surface area corresponding to the optical recording medium 1 which uses the compatible technique A is arranged at this step part. Owing to this, it becomes possible to make the difference between the maximum value and the minimum value of the wavefront aberration be less than or equal to W, thereby reducing the wavefront aberration.

In Embodiment 3, as shown in FIG. 4B, an abrupt change of the wavefront aberration amount occurs between the surface area numbers 6 and 7 and between the surface area numbers 11 and 12.

In present Embodiment 4, as shown in FIG. 7, a medium area for focusing light on an optical recording medium which does not use the compatible technique B is arranged at a step area where the change of the wavefront aberration is the largest and the absolute value of the wavefront aberration is large.

Specifically, as shown in FIG. 7, the surface area numbers 2 and 4 for focusing light on the optical recording medium 2, 3, and 4 are sectioned by the surface area number 3 which focuses light only on the optical recording medium 1 without focusing light on the optical recording medium 2, 3, and 4.

Moreover, as shown in FIG. 8, the optical path length difference OPD of the optical recording medium 2 is approximately −0.0729 to 0.0173λ at the surface area number 2, and −2.0155 to −2.0296 at the surface area number 4. The optical path length difference OPD of the optical recording medium 4 is approximately 0.0206 to 0.0362λ at the surface area number 2, and −0.9794 to −0.9338 at the surface area number 4. Thus, since the surface area number 3 is arranged so that the optical path length difference between the surface area numbers 2 and 4, which are at before and after being sectioned by the surface area number 3, may be greater than or equal to 0.5λ and the change of the wavefront aberration amount of 0.12λ may be suppressed, it turns out that, as shown in FIG. 7, the change of the wavefront aberration amount of the surface area numbers 2 and 4 can be reduced to 0.057λ for the optical recording medium 2, and reduced to 0.065λ for the optical recording medium 3. That is, each of them has been reduced to a value smaller than 0.12λ. As a result, as shown in FIG. 34, it becomes possible to achieve the axial characteristic being less than or equal to 0.03λ and the lens shift characteristic being less than or equal to 0.06λ, thereby providing an objective lens optical system of high performance.

### Embodiment 5

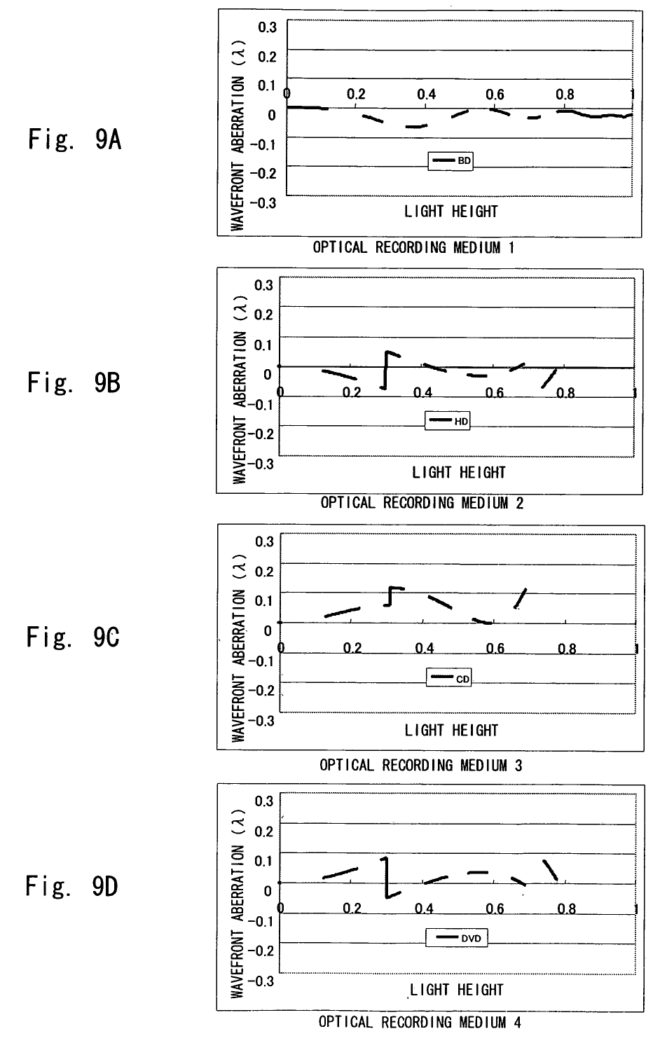

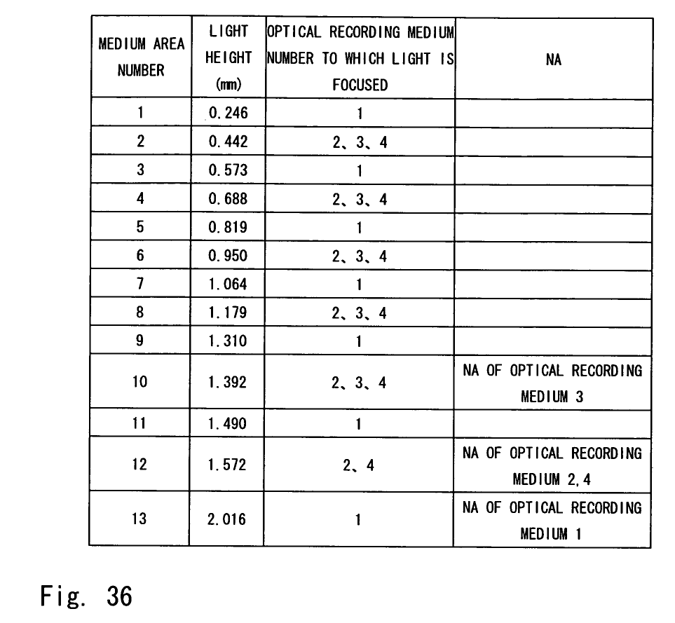

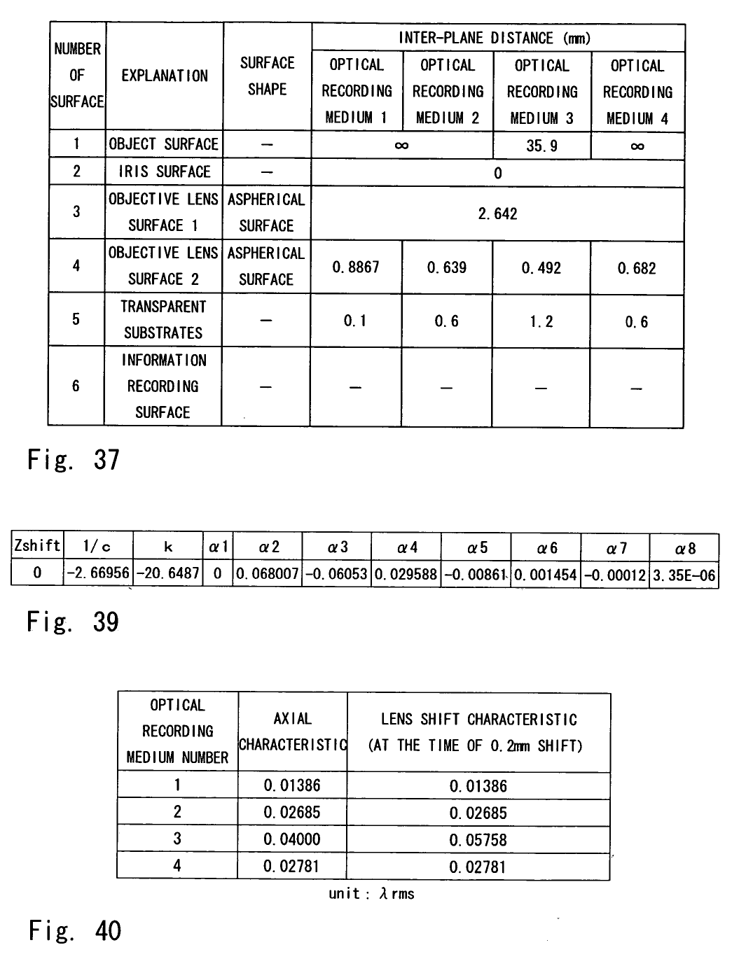

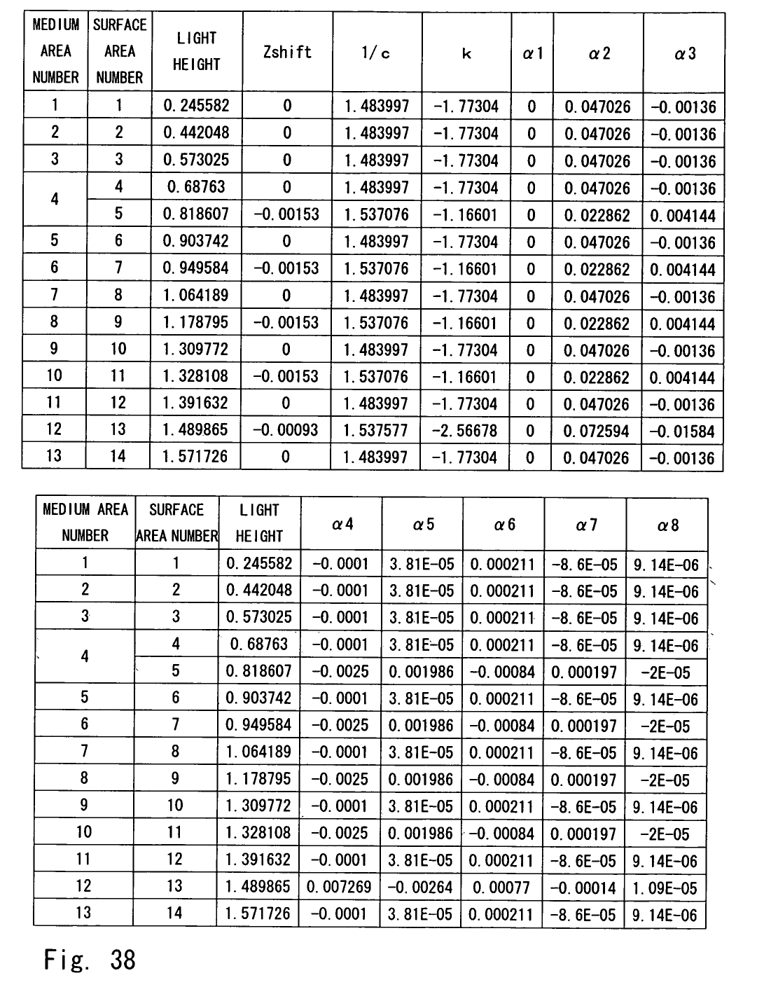

The objective lens optical system according to present Embodiment 5 has the same basic structure as that of Embodiment 3, in which light is focused on the four types of the optical recording medium by using the objective lens optical system shown in FIGS. 35 to 39. FIG. 9 shows features of the objective lens optical system according to Embodiment 5, and FIG. 40 shows RMS wavefront aberration values.

The objective lens optical system according to Embodiment is the same as that of Embodiment 3 except for the structure relevant to the compatible technique B for the optical recording medium 2 and 4. In the objective lens optical system according to Embodiment 3, an optical path length difference between areas is arranged as follows: With respect to the areas specified by the surface area numbers 2 and 4, the optical path length difference is arranged to be approximately 0±0.06λ, that is −0.06λ₂ to +0.06λ₂ for the optical recording medium 2, and to be approximately 0±0.06λ, that is −0.06λ₄ to +0.06λ₄ for the optical recording medium 4. With respect to the areas specified by the surface area numbers 5, 7, 9, and 11, the optical path length difference is arranged to be approximately −2.0±0.06λ, that is −2.06λ₂ to −1.94λ₂ for the optical recording medium 2, and to be approximately −1.0±0.06, that is −1.06λ₄ to −0.94λ₄ for the optical recording medium 4. With respect to the area specified by the surface area number 13, the optical path length difference is arranged to be approximately −0±0.06λ, that is −0.06λ₂ to +0.06λ₂ for the optical recording medium 2, and to be approximately +0±0.06λ, that is −0.06λ₄ to +0.06λ₄ for the optical recording medium 4. Thus, by arranging the optical path length difference as described above, compatibility between the optical recording medium 2 and 4 can be achieved by using the compatible technique B mentioned above.

Furthermore, according to the present Embodiment 5, the technique according to the present invention explained in the Embodiment 5 is applied at an area adjacent to NA 0.7 of the optical recording medium 2 and 4.

In the objective lens optical system according to Embodiment 5, by having such structure, it becomes possible to achieve the axial characteristic being less than or equal to 0.04λ and the lens shift characteristic (at the time of 0.2 mm shift) being less than or equal to 0.06λ as shown in FIG. 40, thereby providing an objective lens optical system of high performance.

### Other Embodiment

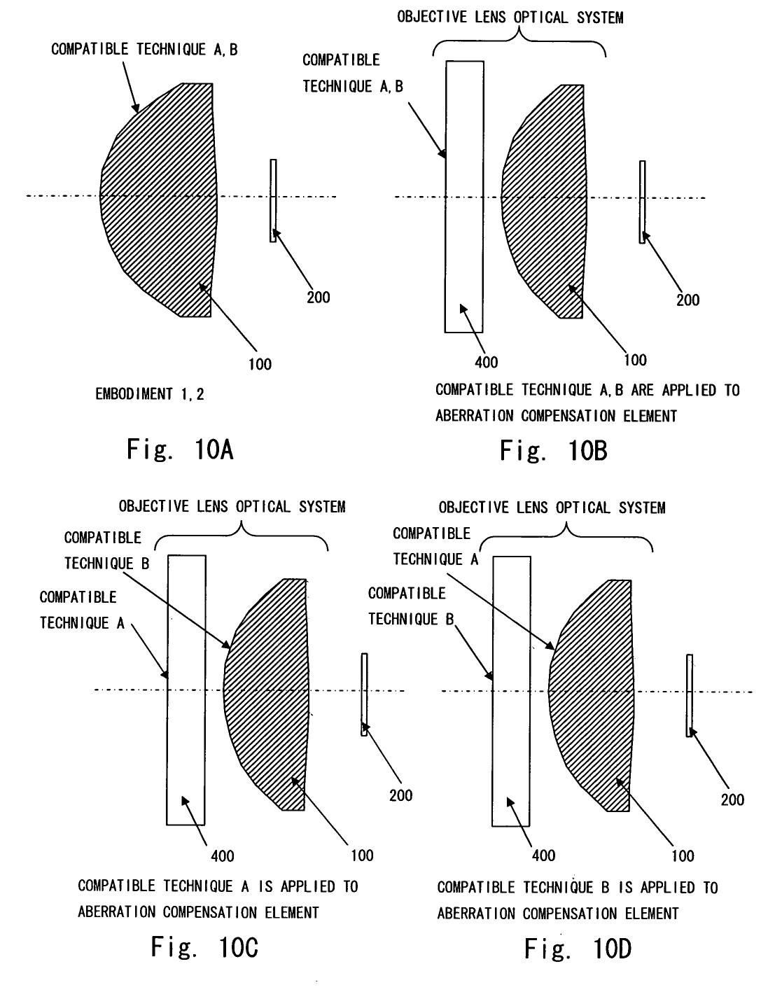

Although the objective lens optical system is realized by one lens in Embodiments 1 to 5, it is also acceptable to use two parts, namely the objective lens 100 and an aberration compensation element 400 as shown in FIG. 10. Specifically, as shown in FIG. 10B, both the compatible technique A and the compatible technique B may be applied to the plane of incidence or the plane of output of the aberration compensation element 400. Moreover, as shown in FIG. 10C, the compatible technique A may be applied to the aberration compensation element 400 and the compatible technique B may be applied to the objective lens 100. Furthermore, as shown in FIG. 10D, the compatible technique B may be applied to the aberration compensation element 400 and the compatible technique A may be applied to the objective lens 100. Even when the objective lens optical system is realized by such a structure, the same effect as that of Embodiment 1 to 5 can be acquired. However, for attaining a reduced size and reduced weight objective lens optical system, it is preferable to realize the system by using one lens like the objective lens optical system according to Embodiments 1 to 5.

In the above Embodiments, the objective lens optical system capable of achieving compatibility of the four types of the optical recording medium has been explained. Furthermore, the present invention is applicable to the objective lens optical system in which wavelengths of light beams to be focused on at least two or more optical recording medium are the same, wavelengths of light beams to be focused on at least two or more optical recording medium are different, and light is focused on at least three or more optical recording medium.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. An objective lens optical system focusing a light beam with a wavelength λ₁ on an information recording surface of a first optical recording medium including a transparent substrate with a thickness t1, a light beam with the wavelength λ₁ on an information recording surface of a second optical recording medium including a transparent substrate with a thickness t2 (t2≠t1), and a light beam with a wavelength λ₃ (λ₃≠λ₁) on an information recording surface of a third optical recording medium including a transparent substrate with a thickness t3 and having a positive power, which comprising:
an area for the first optical recording medium, configured to focus the light beam with the wavelength λ₁ on the information recording surface of the first optical recording medium, without focusing the light beam with the wavelength λ₁ on the information recording surface of the second optical recording medium; and
a common area configured to focus the light beam with the wavelength λ₁ on the information recording surface of the second optical recording medium, without focusing the light beam with the wavelength, on the information recording surface of the first optical recording medium, and to focus the light beam with the wavelength λ₃ on the information recording surface of the third optical recording medium,
wherein, in the common area, an aspherical surface shape is designed to generate an aberration which substantially cancels out a chromatic aberration caused by a difference in wavelength λ of the light beam.

2. The objective lens optical system according to claim 1, wherein, in the common area, the aspherical surface is designed in such a matter that a wavefront aberration caused by a difference in thickness of the transparent substrate of the optical recording medium, the chromatic aberration caused by the difference in wavelength λ of the light beam, and an aberration caused by the aspherical surface shape are substantially cancelled out each other.

3. The objective lens optical system according to claim 1, wherein an optical path length difference between two common areas contiguously at inner and outer sides of the area for the first optical recording medium is greater than or equal to 0.5λ with respect to either one of the wavelength λ₁ and the wavelength λ₃.

4. The objective lens optical system according to claim 1, wherein, the area for the first optical recording medium is provided in an area where a change of a wavefront aberration with respect to the second optical recording medium or the third optical recording medium is the largest when the common area is arranged in all area of one surface of an objective lens.

5. The objective lens optical system according to claim 1, wherein the thickness of the transparent substrate is |t3−t1|>|t3−t2|.

6. The objective lens optical system according to claim 5, wherein the common area is arranged at an outer portion in an NA area of the third optical recording medium.

7. The objective lens optical system according to claim 1, wherein the common area is sectioned into a plurality of sections in a radial direction from an optical axis.

8. The objective lens optical system according to claim 5, further comprising a common area configured to focus light on the information recording surfaces of the first optical recording medium and the third optical recording medium.

9. The objective lens optical system according to claim 1, wherein the objective lens optical system is applied to an optical pickup optical system.

10. An objective lens optical system focusing a light beam with a wavelength λ₁ on an information recording surface of a first optical recording medium including a transparent substrate with a thickness t1, a light beam with the wavelength λ₁ on an information recording surface of a second optical recording medium including a transparent substrate with a thickness t2 (t2≠t1), and a light beam with a wavelength λ₃ (λ₃≠λ₁) on an information recording surface of a third optical recording medium including a transparent substrate with a thickness t3 and having positive power, which comprising:
an area for the first optical recording medium, configured to focus the light beam with the wavelength λ₁ on the information recording surface of the first optical recording medium, without focusing the light beam with the wavelength λ₁ on the information recording surface of the second optical recording medium; and
a common area configured to focus the light beam with the wavelength λ₁ on the information recording surface of the second optical recording medium, without focusing the light beam with the wavelength λ₁ on the information recording surface of the first optical recording medium, and to focus the light beam with the wavelength λ₃ on the information recording surface of the third optical recording medium,
wherein the light beam with the wavelength λ₃ and the light beam with the wavelength λ₁ enter the common area at different incident angles.

11. The objective lens optical system according to claim 10, wherein, in the common area, the aspherical surface is designed in such a matter that a wavefront aberration caused by a difference in thickness of the transparent substrate of the optical recording medium, the chromatic aberration caused by the difference in wavelength λ of the light beam, and an aberration caused by the aspherical surface shape are substantially cancelled out each other.

12. The objective lens optical system according to claim 10, wherein the thickness of the transparent substrate is |t3−t1|>|t3−t2|.

13. The objective lens optical system according to claim 11, wherein the thickness of the transparent substrate is |t3−t1|>|t3−t2|.

14. The objective lens optical system according to claim 10, wherein an optical path length difference between two common areas contiguously at inner and outer sides of the area for the first optical recording medium is greater than or equal to 0.5λ with respect to either one of the wavelength λ₁ and the wavelength λ₃.

15. The objective lens optical system according to claim 10, wherein, the area for the first optical recording medium is provided in an area where a change of a wavefront aberration with respect to the second optical recording medium or the third optical recording medium is the largest when the common area is arranged in all area of one surface of an objective lens.

16. The objective lens optical system according to claim 10, wherein the objective lens optical system is applied to an optical pickup optical system.

17. An objective lens optical system focusing a light beam with a wavelength λ₁ on an information recording surface of a first optical recording medium including a transparent substrate with a thickness t1, a light beam with the wavelength λ₁ on an information recording surface of a second optical recording medium including a transparent substrate with a thickness t2 (t2≠t1), a light beam with a wavelength λ₃ (λ₃≠λ₁) on an information recording surface of a third optical recording medium including a transparent substrate with a thickness t3, and a light beam with a wavelength λ₄ (λ₄≠λ₁) on an information recording surface of a forth optical recording medium including a transparent substrate with a thickness t4 and having positive power, which comprising:
an area for the first optical recording medium, configured to focus the light beam with the wavelength λ₁ on the information recording surface of the first optical recording medium, without focusing the light beam with the wavelength λ₁ on the information recording surface of the second optical recording medium; and
a common area configured to focus the light beam with the wavelength λ₁ on the information recording surface of the second optical recording medium, without focusing the light beam with the wavelength λ₁ on the information recording surface of the first optical recording medium, to focus the light beam with the wavelength λ₃ on the information recording surface of the third optical recording medium, and to focus the light beam with the wavelength λ₄ on the information recording surface of the fourth optical recording medium,
wherein the light beam with the wavelength λ₃ and the light beam with the wavelength λ₁ enter the common area at different incident angles, and in the common area, an aspherical surface shape is designed to mutually cancel out a chromatic aberration caused by a difference between the wavelength λ₄ and the wavelength λ₁ of the light beams.

18. The objective lens optical system according to claim 17, wherein, in the common area, the aspherical surface shape is designed in such a matter that a wavefront aberration caused by a difference in thickness of the transparent substrates of the second optical recording medium and the fourth optical recording medium, the chromatic aberration caused by the difference between the wavelength λ₄ and the wavelength λ₁ of the light beams, and an aberration caused by the aspherical surface shape are substantially cancelled out each other.

19. The objective lens optical system according to claim 17, wherein the thickness of the transparent substrate is |t3−t1|>|t3−t2| or/and |t4−t1|>|t4−t2|.

20. The objective lens optical system according to claim 18, wherein the thickness of the transparent substrate is |t3−t1|>|t3−t2| or/and |t4−t1|>|t4−t2|.

21. The objective lens optical system according to claim 17, wherein an optical path length difference between two common areas contiguously at inner and outer sides of the area for the first optical recording medium is greater than or equal to 0.5λ with respect to one of the wavelength λ₁, the wavelength λ₃, and the wavelength λ₄.

22. The objective lens optical system according to claim 17, wherein, the area for the first optical recording medium is provided in an area where a change of a wavefront aberration with respect to the second optical recording medium, the third optical recording medium, or the fourth optical recording medium is the largest when the common area is arranged in all area of an objective lens.

23. The objective lens optical system according to claim 17, wherein the objective lens optical system is composed of one lens.

24. The objective lens optical system according to claim 17, wherein the objective lens optical system is applied to an optical pickup optical system.
